(19) United States
(12) Patent Application Publication
(10) Pub. No.: US 2026/0160983 A1
(43) Pub. Date: Jun. 11, 2026

(54) OPTICAL IMAGING SYSTEM

(71) Applicant: Samsung Electro-Mechanics Co., Ltd., Suwon-si (KR)

(72) Inventors: Seong Il CHO, Suwon-si (KR); Tae Yeon LIM, Suwon-si (KR); Woo Young KIM, Suwon-si (KR); Jae Hyuk HUH, Suwon-si (KR)

(73) Assignee: Samsung Electro-Mechanics Co., Ltd., Suwon-si (KR)

(21) Appl. No.: 19/324,738

(22) Filed: Sep. 10, 2025

(30) Foreign Application Priority Data
Dec. 6, 2024 (KR) 10-2024-0180902

(51) Int. Cl. G02B 15/14; G02B 9/64; G02B 13/00; G02B 13/02

(52) U.S. Cl. CPC G02B 15/142; G02B 9/64; G02B 13/0065; G02B 13/02

(57) ABSTRACT

An optical imaging system includes a first lens group including a first lens and a second lens sequentially disposed along a first optical axis, a second lens group including a third lens, a fourth lens, a fifth lens, a sixth lens, and a seventh lens sequentially disposed along a second optical axis perpendicular to the first optical axis, and an optical path conversion member disposed between the first lens group and the second lens group, the optical path conversion member being configured to change a traveling direction of light from a direction of the first optical axis to a direction of the second optical axis, wherein a conditional expression 0.5≤|f/f1|+|f/f2|≤1.5 is satisfied, where f is a focal length of the optical imaging system, f1 is a focal length of the first lens, and f2 is a focal length of the second lens.

### CROSS-REFERENCE TO RELATED APPLICATIONS

This application claims the benefit under 35 USC 119 (a) of Korean Patent Application No. 10-2024-0180902 filed on Dec. 6, 2024, in the Korean Intellectual Property Office, the entire disclosure of which is incorporated herein by reference for all purposes.

### BACKGROUND

### 1. Field

The present disclosure relates to an optical imaging system for a telephoto camera.

### 2. Description of Background

In the recent mobile camera market, demands for slim high-magnification telephoto cameras have been increasing.

Since high-magnification telephoto cameras necessitate a long focal length, a prism for bending a path of light may be disposed in front of a lens of high-magnification telephoto camera.

In addition, to implement a high-magnification camera with a low F-number, a folded optics type has been proposed, in which a large-diameter lens is disposed lying down in front of a prism.

However, when only one lens is disposed in front of the prism, there are limitations in aberration correction and slimming of a high-magnification camera.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group including a first lens and a second lens sequentially disposed in ascending numerical order along a first optical axis from an object side of the first lens group toward an image side of the first lens group; a second lens group including a third lens, a fourth lens, a fifth lens, a sixth lens, and a seventh lens sequentially disposed in ascending numerical order along a second optical axis perpendicular to the first optical axis from an object side of the second lens group toward an imaging plane of the optical imaging system; and an optical path conversion member disposed between the first lens group and the second lens group, the optical path conversion member being configured to change a traveling direction of light from a direction of the first optical axis to a direction of the second optical axis, wherein a conditional expression 0.5≤|f/f1|+|f/f2|≤1.5 is satisfied, where f is a focal length of the optical imaging system, f1 is a focal length of the first lens, and f2 is a focal length of the second lens.

Thee first lens and the second lens may have refractive powers of opposite signs.

A conditional expression 1≤fG1/f≤3 may be satisfied, where fG1 is a focal length of the first lens group.

A conditional expression 2≤f3/f4≤−1 may be satisfied, where f3 is a focal length of the third lens, and f4 is a focal length of the fourth lens.

A conditional expression 1.0≤(F-number*SD1)/f≤3.0 may be satisfied, where SD1 is a diameter of the first lens, and F-number is a value representing a brightness of the optical imaging system.

A conditional expression 1.5≤f/BFL≤3.0 may be satisfied, where f is a focal length of the optical imaging system, and BFL is a distance along the second optical axis from an image-side surface of the seventh lens to the imaging plane.

The third lens may have a positive refractive power, the fourth lens may have a negative refractive power, the fifth lens may have a positive refractive power, the sixth lens may have a negative refractive power, and the seventh lens may have a positive refractive power.

An object-side surface of the third lens may have a convex shape in a paraxial region thereof, and an image-side surface of the fourth lens may have a concave shape in a paraxial region thereof.

The first lens may have a positive refractive power, and an image-side surface of the first lens may have a convex shape in a paraxial region thereof.

The first lens may have a negative refractive power, and an image-side surface of the first lens may have a concave shape in a paraxial region thereof.

The second lens may have a negative refractive power, and an image-side surface of the second lens may have a concave shape in a paraxial region thereof.

The second lens may have a negative refractive power, and an image-side surface of the second lens may have a convex shape in a paraxial region thereof.

The second lens may have a positive refractive power, and an image-side surface of the second lens may have a convex shape in a paraxial region thereof.

Both an object-side surface and an image-side surface of the sixth lens may have a concave shape in respective paraxial regions thereof.

An image-side surface of the fifth lens may have a convex shape in a paraxial region thereof, and an object-side surface of the seventh lens may have a convex shape in a paraxial region thereof.

In another general aspect, an optical imaging system includes an optical path conversion member configured to change a path of light passing through the optical imaging system; a first lens group disposed on an object side of the optical path conversion member, the first lens group including a plurality of lenses sequentially disposed along a first optical axis; and a second lens group disposed on an image side of the optical path conversion member, the second lens group including a plurality of lenses sequentially disposed along a second optical axis perpendicular to the first optical axis, wherein a total number of lenses in the second lens group is greater than a total number of lenses in the first lens group, and a conditional expression 1.0≤fG2/dG1G2≤4.5 is satisfied, where fG2 is a focal length of the second lens group, and dG1G2 is a distance along the first optical axis and the second optical axis between the first lens group and the second lens group.

The plurality of lenses of the first lens group may include a first lens and a second lens sequentially disposed in ascending numerical order along the first optical axis from an object side of the first lens group toward the optical path conversion member, the plurality of lenses of the second lens group may include a third lens, a fourth lens, a fifth lens, a sixth lens, and a seventh lens sequentially disposed in ascending numerical order along the second optical axis from an object side of the second lens group toward an imaging plane of the optical imaging system, and a conditional expression-2≤f3/f4≤−1 may be satisfied, where f3 is a focal length of the third lens, and f4 is a focal length of the fourth lens.

The first lens and the second lens may have refractive powers of opposite signs, the third lens, the fifth lens, and the seventh lens may have positive refractive powers, and the fourth lens and the sixth lens may have negative refractive powers.

A conditional expression 5°/mm≤FOV/IMG HT≤9°/mm may be satisfied, where FOV is a field of view of the optical imaging system, and IMG HT is one half of a diagonal length of an imaging plane of the optical imaging system.

A conditional expression 1≤h1/h2≤3 may be satisfied, where h1 is a maximum height of the optical imaging system along the first optical axis, and h2 is a maximum height of the second lens group along the first optical axis.

Other features and aspects will be apparent from the following detailed description, the drawings, and the claims.

### BRIEF DESCRIPTION OF DRAWINGS

FIG. 1A is a configuration diagram illustrating an optical imaging system according to a first embodiment of the present disclosure.

FIG. 1B is a graph illustrating aberration properties of the optical imaging system according to the first embodiment of the present disclosure.

FIG. 2A is a configuration diagram illustrating an optical imaging system according to a second embodiment of the present disclosure.

FIG. 2B is a graph illustrating aberration properties of the optical imaging system according to the second embodiment of the present disclosure.

FIG. 3A is a configuration diagram illustrating an optical imaging system according to a third embodiment of the present disclosure.

FIG. 3B is a graph illustrating aberration properties of the optical imaging system according to the third embodiment of the present disclosure.

FIG. 4A is a configuration diagram illustrating an optical imaging system according to a fourth embodiment of the present disclosure.

FIG. 4B is a graph illustrating aberration properties of the optical imaging system according to the fourth embodiment of the present disclosure.

FIG. 5A is a configuration diagram illustrating an optical imaging system according to a fifth embodiment of the present disclosure.

FIG. 5B is a graph illustrating aberration properties of the optical imaging system according to the fifth embodiment of the present disclosure.

FIG. 6A is a configuration diagram illustrating an optical imaging system according to a sixth embodiment of the present disclosure.

FIG. 6B is a graph illustrating aberration properties of the optical imaging system according to the sixth embodiment of the present disclosure.

FIG. 7A is a configuration diagram illustrating an optical imaging system according to a seventh embodiment of the present disclosure.

FIG. 7B is a graph illustrating aberration properties of the optical imaging system according to the seventh embodiment of the present disclosure.

FIG. 8A is a configuration diagram illustrating an optical imaging system according to an eighth embodiment of the present disclosure.

FIG. 8B is a graph illustrating aberration properties of the optical imaging system according to the eighth embodiment of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the optical system configuration diagrams in the drawings, the thicknesses, sizes, and shapes of the lenses may be exaggerated for clarity of illustration. In particular, the aspherical shapes of the lens surfaces illustrated in the configuration diagrams are only presented as examples, but are not limited thereto.

As used herein, a first lens may refer to a lens disposed closest to an object side of an optical imaging system, and a seventh lens may refer to a lens disposed closest to an imaging plane of the optical imaging system (or an image sensor).

In addition, as used herein, numerical values of a radius of curvature, a thickness, a distance, a focal length, and other dimensions are expressed in millimeters (mm), and a field of view (FOV) is expressed in degrees (*).

In addition, in a description of a shape of a lens, a statement that a surface of a lens has a convex shape means that a paraxial region of the surface is convex, and a statement that a surface of a lens has a concave shape means that a paraxial region of the surface is concave. Accordingly, even when it is stated that a surface of a lens has a convex shape, an edge portion of the surface of the lens may have a concave shape. Similarly, even when it is stated that a surface of a lens has a concave shape, an edge portion of the surface of the lens may have a convex shape.

A paraxial region of a lens surface is a very narrow region of the lens surface around an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

An optical imaging system according to embodiments of the present disclosure may include seven lenses. For example, the optical imaging system according to embodiments of the present disclosure may include a first lens, a second lens, a third lens, a fourth lens, a fifth lens, a sixth lens, and a seventh lens sequentially disposed in ascending numerical order along an optical axis of the optical imaging system from an object side of the optical imaging system toward an imaging plane of the optical imaging system.

However, the optical imaging system according to embodiments of the present disclosure may not include only seven lenses, and may further include other components as needed.

The optical imaging system according to embodiments of the present disclosure may further include an image sensor for converting incident light from a subject into an electrical signal.

In addition, the optical imaging system according to embodiments of the present disclosure may further include an infrared blocking filter (hereinafter referred to as a filter) blocking infrared light in a wavelength range incident on the image sensor.

In addition, the optical imaging system according to embodiments of the present disclosure may further include an optical path conversion member for changing a path of incident light toward the image sensor. For example, the optical path conversion member may be provided as a prism or a mirror having a reflective surface.

In addition, the optical imaging system according to embodiments of the present disclosure may further include a stop for adjusting an amount of light passing through the optical imaging system. For example, the stop may be disposed between two adjacent lenses.

The optical imaging system according to embodiments of the present disclosure may include a lens made of a plastic material. For example, the first to seventh lenses may all be lenses made of a plastic material.

In addition, at least one of the first to seventh lenses may have an aspherical surface. For example, each of the first to seventh lenses may have at least one aspherical surface. The aspherical surfaces of the first to seventh lenses are defined by Equation 1 below.

$$Z = \frac{c {Y}^{2}}{1 + \sqrt{1 - ( 1 + K ) {c}^{2} {Y}^{2}}} + A {Y}^{4} + B {Y}^{6} + C {Y}^{8} + D {Y}^{10} + E {Y}^{12} + F {Y}^{14} + G {Y}^{16} + H {Y}^{18} + J {Y}^{20} + L {Y}^{22} + M {Y}^{24} + N {Y}^{26} + {OY}^{28} + P {Y}^{30} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

The optical imaging system according to embodiments of the present disclosure may include two lens groups. For example, the optical imaging system according to an embodiment of the present disclosure may include a first lens group and a second lens group sequentially disposed in ascending numerical order along an optical axis of the optical imaging stem from an object side of the optical imaging system toward an imaging plane of the optical imaging system.

The first lens group and the second lens group may each include a plurality of lenses disposed along different optical axes. For example, the first lens group may include a first lens and a second lens sequentially disposed in ascending numerical order along a first optical axis, and the second lens group may include a third lens, a fourth lens, a fifth lens, a sixth lens, and a seventh lens sequentially disposed in ascending numerical order along a second optical axis. The first optical axis and the second optical axis may be perpendicular or substantially perpendicular to each other.

The optical path conversion member may be disposed between the first lens group and the second lens group. For example, the optical path conversion member may change a path of incident light from a direction of the first optical axis to a direction of the second optical axis.

The first lens group may include lenses having opposite refractive powers. That is, refractive powers of the first lens and the second lens may be opposite to each other. For example, the first lens may have a positive refractive power, and the second lens may have a negative refractive power. Alternatively, the first lens may have a negative refractive power, and the second lens may have a positive refractive power.

In the second lens group, lenses having opposite refractive powers may be alternately disposed along the optical axis. That is, refractive powers of two adjacent lenses may be opposite to each other. For example, the third lens may have a positive refractive power, the fourth lens may have a negative refractive power, the fifth lens may have a positive refractive power, the sixth lens may have a negative refractive power, and the seventh lens may have a positive refractive power.

According to embodiments of the present disclosure, the first lens group and the second lens group may each include a plurality of lenses, and adjacent lenses may have opposite refractive powers, thereby improving aberration correction performance of the optical imaging system. In addition, the first lens group may include a plurality of lenses, thereby lowering an F-number while minimizing an increase in a height of a telephoto camera module including the optical imaging system.

The optical imaging system according to embodiments of the present disclosure may satisfy any one or any combination of any two or more of Conditional Expressions 1 to 8 below.

$$0.5 \leq \vert f / f 1 \vert + \vert f / f 2 \vert \leq 1.5 \qquad ( Conditional Expression 1 )$$

$$- 2 \leq f 3 / f 4 \leq - 1 \qquad ( Conditional Expression 2 )$$

$$1 \leq fG 1 / f \leq 3 \qquad ( Conditional Expression 3 )$$

$$5 ° / mm \leq FOV / IMG HT \leq 9 ° / mm \qquad ( Conditional Expression 4 )$$

$$1. \leq fG 2 / dG 1 G 2 \leq 4.5 \qquad ( Conditional Expression 5 )$$

$$1.5 \leq h 1 / h 2 \leq 3. \qquad ( Conditional Expression 6 )$$

$$1.5 \leq f / BFL \leq 3. \qquad ( Conditional Expression 7 )$$

$$1. \leq ( F - number * SD 1 ) / f \leq 3.0 \qquad ( Conditional Expression 8 )$$

In Conditional Expression 1, f is a focal length of the optical imaging system, f1 is a focal length of the first lens, and f2 is a focal length of the second lens. Conditional Expression 1 is related to power conditions (reciprocals of focal lengths) of the first lens and the second lens for reducing aberrations of the optical imaging system.

In Conditional Expression 2, f3 is a focal length of the third lens, and f4 is a focal length of the fourth lens. Conditional Expression 2 is related to power conditions (reciprocals of focal lengths) of the third and fourth lenses for reducing aberrations of the optical imaging system.

In Conditional Expression 3, f is a focal length of the optical imaging system, and fG1 is a focal length of the first lens group (or a composite focal length of the first lens and the second lens). Conditional Expression 3 is related to a power condition (a reciprocal of a focal length) of the first lens group for reducing a size of the second lens group.

In Conditional Expression 4, FOV is a field of view of the optical imaging system, and IMG HT is one half of a diagonal length of an imaging plane. Conditional Expression 4 may represent a field of view of a lens.

In Conditional Expression 5, fG2 is a focal length of the second lens group (or a composite focal length of the third lens, the fourth lens, the fifth lens, the sixth lens, and the seventh lens), and dG1G2 is a distance along an optical axis between the first lens group and the second lens group (or a sum of a distance along a first optical axis from an image-side surface of the second lens to a reflective surface of an optical path conversion member and a distance along a second optical axis from the reflective surface to an object-side surface of the third lens). Conditional Expression 5 is related to a leading lens effect of the first lens group. When a range of Conditional Expression 5 is satisfied, it is considered that a goal of minimizing an increase in a height of a telephoto camera module including the optical imaging system is achieved.

In Conditional Expression 6, h1 is a maximum height of the optical imaging system along the first optical axis, and h2 is a maximum height of the second lens group along the first optical axis. A direction of the first optical axis corresponds to a height direction of a telephoto camera module including the optical imaging system. Conditional Expression 6 is related to the leading lens effect of the first lens group. When a range of Conditional Expression 6 is satisfied, it is considered that a goal of minimizing an increase in a height of the telephoto camera module including the optical imaging system is achieved.

In Conditional Expression 7, f is a focal length of the optical imaging system, and BFL is a distance along the optical axis from an image-side surface of the seventh lens to the imaging plane. Conditional Expression 7 is related to telephoto camera properties.

In Conditional Expression 8, SD1 is a diameter of the first lens, and F-number is a value representing a brightness of the optical imaging system, and is equal to a focal length of the optical imaging system divided by a diameter of an entrance pupil of the optical imaging system. Conditional Expression 8 may represent a relationship between the diameter of the first lens and the F-number in a front-lens-type optical system.

The optical imaging system according to embodiments of the present disclosure may further satisfy any one or any combination of any two or more of Conditional Expressions 9 to 15 below.

$$- 0.5 \leq f / f 1 \leq 1. \qquad ( Conditional Expression 9 )$$

$$- 0.5 \leq f / f 2 \leq 1. \qquad ( Conditional Expression 10 )$$

$$1 \leq f / f 3 \leq 3 \qquad ( Conditional Expression 11 )$$

$$- 5 < f / f 4 \leq - 1 \qquad ( Conditional Expression 12 )$$

$$2 \leq f / f 5 < 5 \qquad ( Conditional Expression 13 )$$

$$- 10 \leq f / f 6 < 0 \qquad ( Conditional Expression 14 )$$

$$1 \leq f / f 7 < 3 \qquad ( Conditional Expression 15 )$$

In Conditional Expressions 9 to Conditional Expressions 15, f is a focal length of the optical imaging system, f1 is a focal length of the first lens, f2 is a focal length of the second lens, f3 is a focal length of the third lens, f4 is a focal length of the fourth lens, f5 is a focal length of the fifth lens, f6 is a focal length of the sixth lens, and f7 is a focal length of the seventh lens. When the ranges of Conditional Expressions 9 to Conditional Expressions 15 are satisfied, individual lenses may have appropriate refractive powers, thereby providing acceptable aberration properties.

### First Embodiment

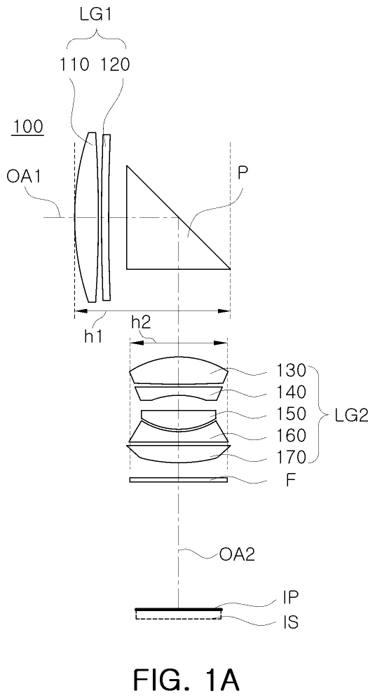

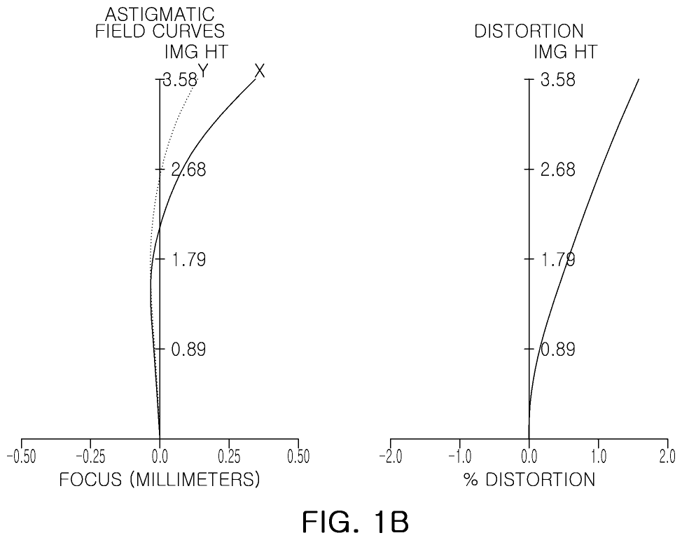

FIG. 1A is a configuration diagram illustrating an optical imaging system according to a first embodiment of the present disclosure. FIG. 1B is a graph illustrating aberration properties of the optical imaging system according to the first embodiment of the present disclosure.

Referring to FIG. 1A, an optical imaging system 100 according to the first embodiment of the present disclosure may include a first lens 110, a second lens 120, a third lens 130, a fourth lens 140, a fifth lens 150, a sixth lens 160, and a seventh lens 170 sequentially disposed in ascending numerical order along an optical axis of the optical imaging system 100 from an object side of the optical imaging system 100 toward an imaging plane IP of the optical imaging system 100. In addition, an image sensor IS having a filter F and the imaging plane IP may be disposed on an image side of the seventh lens 170. In addition, although not illustrated in the drawings, a stop may be disposed between the fifth lens 150 and the sixth lens 160.

The optical imaging system 100 according to the first embodiment of the present disclosure may include a first lens group LG1 and a second lens group LG2, and an optical path conversion member P may be disposed between the first lens group LG1 and the second lens group LG2. That is, the first lens group LG1 and the second lens group LG2 may have different optical axes.

According to the first embodiment of the present disclosure, the first lens group LG1 may include a first lens 110 and a second lens 120 sequentially disposed along a first optical axis OA1. The second lens group LG2 may include a third lens 130, a fourth lens 140, a fifth lens 150, a sixth lens 160, and a seventh lens 170 sequentially disposed along a second optical axis OA2. The optical path conversion member P may change a path of incident light from a direction of the first optical axis OA1 to a direction of the second optical axis OA2.

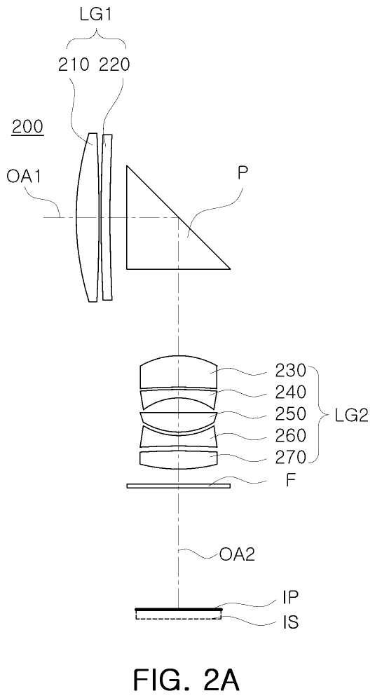

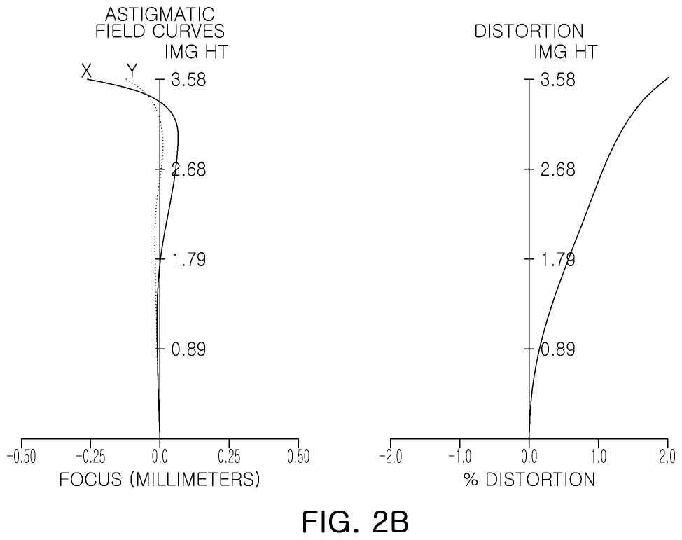

In FIG. 1A, h1 is a maximum height of the optical imaging system 100 along the first optical axis OA1, and h2 is a maximum height of the second lens group LG2 along the first optical axis OA1. The direction of the first optical axis OA1 corresponds to a height direction of a telephoto camera module including the optical imaging system 100. The dimensions h1 and h2 are also applicable to FIGS. 2A, 3A, 4A, 5A, 6A, 7A, and 8A, although they are not shown in those figures.

Properties of the lenses included in the optical imaging system 100 according to the first embodiment of the present disclosure are listed in Table 1 below.

TABLE 1

| Surface | | Radius of | Thickness/ | Refractive | Abbe | Effective Radius | |
|---|---|---|---|---|---|---|---|
| No. | Element | Curvature | Distance | Index | Number | X-Axis | Y-Axis |
| S1 | First | 13.260 | 1.091 | 1.535 | 55.7 | 4.300 | 4.300 |
| S2 | Lens | −91.856 | 0.209 | | | 4.260 | 4.260 |
| S3 | Second | 139.102 | 0.400 | 1.614 | 25.9 | 4.181 | 4.181 |
| S4 | Lens | 55.676 | 0.800 | | | 4.113 | 4.113 |
| S5 | Prism | Infinity | 2.600 | 1.717 | 29.5 | | |
| S6 | | Infinity | 2.600 | 1.717 | 29.5 | | |
| S7 | | Infinity | 4.500 | | | | |
| S8 | Third | 4.206 | 1.392 | 1.535 | 55.7 | 2.400 | 1.900 |
| S9 | Len | −88.403 | 0.100 | | | 2.207 | 1.900 |
| S10 | Fourth | −125.475 | 0.417 | 1.614 | 25.9 | 2.153 | 1.900 |
| S11 | Lens | 2.994 | 0.733 | | | 1.833 | 1.833 |
| S12 | Fifth | −301.728 | 1.044 | 1.535 | 55.7 | 1.824 | 1.824 |
| S13 | Lens | −2.070 | 0.194 | | | 1.803 | 1.803 |
| S14 | Sixth | −1.948 | 0.457 | 1.567 | 37.4 | 1.793 | 1.793 |
| S15 | Lens | 14.061 | 0.100 | | | 2.404 | 1.800 |
| S16 | Seventh | 17.411 | 0.919 | 1.671 | 19.2 | 2.512 | 1.800 |
| S17 | Lens | −6.838 | 0.774 | | | 2.600 | 1.800 |
| S18 | Filter | Infinity | 0.210 | 1.517 | 64.2 | | |
| S19 | | Infinity | 6.482 | | | | |
| S20 | Imaging | Infinity | | | | | |
| | Plane | | | | | | |

According to the first embodiment of the present disclosure, the first lens 110 may have a positive refractive power, and both an object-side surface and an image-side surface of the first lens 110 may have a convex shape in respective paraxial regions thereof. The second lens 120 may have a negative refractive power, an object-side surface of the second lens 120 may have a convex shape in a paraxial region thereof, and an image-side surface of the second lens 120 may have a concave shape in a paraxial region thereof. The third lens 130 may have a positive refractive power, and both an object-side surface and an image-side surface of the third lens 130 may have a convex shape in respective paraxial regions thereof. The fourth lens 140 may have a negative refractive power, and both an object-side surface and an image-side surface of the fourth lens 140 may have a concave shape in respective paraxial regions thereof. The fifth lens 150 may have a positive refractive power, an object-side surface of the fifth lens 150 may have a concave shape in a paraxial region thereof, and an image-side surface of the fifth lens 150 may have a convex shape in a paraxial region thereof. The sixth lens 160 may have a negative refractive power, and both an object-side surface and an image-side surface of the sixth lens 160 may have a concave shape in respective paraxial regions thereof. The seventh lens 170 may have a positive refractive power, and both an object-side surface and an image-side surface of the seventh lens 170 may have a convex shape in respective paraxial regions thereof.

A conic constant K and aspherical surface coefficients A to H, J, and L to P according to Equation 1 discussed above of the lenses included in the optical imaging system 100 according to the first embodiment of the present disclosure are listed in Table 2 below. According to the first embodiment, both an object-side surface and an image-side surface of each of the first lens 110 to the seventh lens 170 may be aspheric surfaces.

TABLE 2

| Surface | | | | | |
|---|---|---|---|---|---|
| No. | S1 | S2 | S3 | S4 | S8 |
| K | −0.363 | 0.000 | 6.914 | −64.324 | 0.000 |
| A | −6.224E−05 | 3.874E−05 | 4.460E−07 | −3.455E−05 | 1.083E−04 |
| B | −1.721E−06 | −1.184E−07 | 1.174E−06 | −1.136E−06 | −1.833E−05 |
| C | −1.369E−08 | −2.850E−08 | 7.887E−09 | 6.578E−08 | −1.010E−05 |
| D | 0.000E+00 | 0.000E+00 | 0.000E+00 | 0.000E+00 | −3.074E−06 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | | |
|---|---|---|---|---|---|
| No. | S9 | S10 | S11 | S12 | S13 |
| K | 0.037 | 10.000 | −0.494 | −80.000 | −3.167 |
| A | −1.432E−03 | −1.537E−04 | 7.000E−03 | 2.166E−04 | −1.154E−04 |
| B | 9.159E−03 | −7.736E−05 | −1.512E−02 | −1.936E−05 | 1.521E−04 |
| C | −9.994E−03 | 4.923E−06 | 1.730E−02 | 2.194E−05 | 3.668E−05 |
| D | 6.161E−03 | 6.059E−06 | −1.131E−02 | 0.000E+00 | 0.000E+00 |
| E | −2.426E−03 | 0.000E+00 | 4.293E−03 | 0.000E+00 | 0.000E+00 |
| F | 6.119E−04 | 0.000E+00 | −8.063E−04 | 0.000E+00 | 0.000E+00 |
| G | −9.532E−05 | 0.000E+00 | 1.132E−05 | 0.000E+00 | 0.000E+00 |
| H | 8.344E−06 | 0.000E+00 | 2.062E−05 | 0.000E+00 | 0.000E+00 |
| J | −3.136E−07 | 0.000E+00 | −2.375E−06 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | |
|---|---|---|---|---|
| No. | S14 | S15 | S16 | S17 |
| K | −3.408 | −38.077 | −78.432 | −1.277 |
| A | 5.331E−04 | −1.099E−03 | 9.299E−05 | 2.631E−03 |
| B | −1.071E−05 | −2.255E−04 | −2.438E−04 | 2.142E−04 |
| C | −4.329E−05 | −6.537E−05 | −2.804E−05 | −1.279E−03 |
| D | 0.000E+00 | 0.000E+00 | 0.000E+00 | 8.834E−04 |
| E | 0.000E+00 | 0.000E+00 | 0.000E+00 | −3.395E−04 |
| F | 0.000E+00 | 0.000E+00 | 0.000E+00 | 7.972E−05 |
| G | 0.000E+00 | 0.000E+00 | 0.000E+00 | −1.132E−05 |
| H | 0.000E+00 | 0.000E+00 | 0.000E+00 | 8.930E−07 |
| J | 0.000E+00 | 0.000E+00 | 0.000E+00 | −3.004E−08 |
| L | 0.000E+00 | 0.000E+00 | 0.000E+00 | 0.000E+00 |
| M | 0.000E+00 | 0.000E+00 | 0.000E+00 | 0.000E+00 |
| N | 0.000E+00 | 0.000E+00 | 0.000E+00 | 0.000E+00 |
| O | 0.000E+00 | 0.000E+00 | 0.000E+00 | 0.000E+00 |
| P | 0.000E+00 | 0.000E+00 | 0.000E+00 | 0.000E+00 |

### Second Embodiment

FIG. 2A is a configuration diagram illustrating an optical imaging system according to a second embodiment of the present disclosure. FIG. 2B is a graph illustrating aberration properties of the optical imaging system according to the second embodiment of the present disclosure.

Referring to FIG. 2A, an optical imaging system 200 according to the second embodiment of the present disclosure may include a first lens 210, a second lens 220, a third lens 230, a fourth lens 240, a fifth lens 250, a sixth lens 260, and a seventh lens 270 sequentially disposed in ascending numerical order along an optical axis of the optical imaging system 200 from an object side of the optical imaging system 200 toward an imaging plane IP of the optical imaging system 200. In addition, an image sensor IS having a filter F and the imaging plane IP may be disposed on an image side of the seventh lens 270. In addition, although not illustrated in the drawings, a stop may be disposed between the fifth lens 250 and the sixth lens 260.

The optical imaging system 200 according to the second embodiment of the present disclosure may include a first lens group LG1 and a second lens group LG2, and an optical path conversion member P may be disposed between the first lens group LG1 and the second lens group LG2. That is, the first lens group LG1 and the second lens group LG2 may have different optical axes.

According to the second embodiment of the present disclosure, the first lens group LG1 may include a first lens 210 and a second lens 220 sequentially disposed along a first optical axis OA1. The second lens group LG2 may include a third lens 230, a fourth lens 240, a fifth lens 250, a sixth lens 260, and a seventh lens 270 sequentially disposed along a second optical axis OA2. The optical path conversion member P may change a path of incident light from a direction of the first optical axis OA1 to a direction of the second optical axis OA2.

Properties of lenses included in the optical imaging system 200 according to the second embodiment of the present disclosure are listed in Table 3 below.

TABLE 3

| Surface | | Radius of | Thickness/ | Refractive | Abbe | Effective Radius | |
|---|---|---|---|---|---|---|---|
| No. | Element | Curvature | Distance | Index | Number | X-Axis | Y-Axis |
| S1 | First | 13.288 | 1.200 | 1.535 | 55.7 | 4.300 | 4.300 |
| S2 | Lens | −138.069 | 0.100 | | | 4.238 | 4.238 |
| S3 | Second | 98.426 | 0.400 | 1.614 | 25.9 | 4.190 | 4.190 |
| S4 | Lens | 47.745 | 0.800 | | | 4.118 | 4.118 |
| S5 | Prism | Infinity | 2.600 | 1.717 | 29.5 | | |
| S6 | | Infinity | 2.600 | 1.717 | 29.5 | | |
| S7 | | Infinity | 4.500 | | | | |
| S8 | Third | 4.163 | 1.558 | 1.535 | 55.7 | 2.400 | 1.900 |
| S9 | Len | 80.377 | 0.100 | | | 2.143 | 1.900 |
| S10 | Fourth | 72.865 | 0.421 | 1.614 | 25.9 | 2.096 | 1.900 |
| S11 | Lens | 3.047 | 0.708 | | | 1.796 | 1.796 |
| S12 | Fifth | 740.167 | 1.029 | 1.535 | 55.7 | 1.785 | 1.785 |
| S13 | Lens | −2.072 | 0.218 | | | 1.757 | 1.757 |
| S14 | Sixth | −1.948 | 0.489 | 1.567 | 37.4 | 1.784 | 1.784 |
| S15 | Lens | 17.411 | 0.209 | | | 2.095 | 1.800 |
| S16 | Seventh | 22.557 | 0.895 | 1.671 | 19.2 | 2.179 | 1.800 |
| S17 | Lens | −7.177 | 0.774 | | | 2.600 | 1.800 |
| S18 | Filter | Infinity | 0.210 | 1.517 | 64.2 | | |
| S19 | | Infinity | 6.182 | | | | |
| S20 | Imaging | Infinity | | | | | |
| | Plane | | | | | | |

According to the second embodiment of the present disclosure, the first lens 210 may have a positive refractive power, and both an object-side surface and an image-side surface of the first lens 210 may have a convex shape in respective paraxial regions thereof. The second lens 220 may have a negative refractive power, an object-side surface of the second lens 220 may have a convex shape in a paraxial region thereof, and an image-side surface of the second lens 220 may have a concave shape in a paraxial region thereof. The third lens 230 may have a positive refractive power, an object-side surface of the third lens 230 may have a convex shape in a paraxial region thereof, and an image-side surface of the third lens 230 may have a concave shape in a paraxial region thereof. The fourth lens 240 may have a negative refractive power, an object-side surface of the fourth lens 240 may have a convex shape in a paraxial region thereof, and an image-side surface of the fourth lens 240 may have a concave shape in a paraxial region thereof. The fifth lens 250 may have a positive refractive power, and both an object-side surface and an image-side surface of the fifth lens 250 may have a convex shape in respective paraxial regions thereof. The sixth lens 260 may have a negative refractive power, and both an object-side surface and an image-side surface of the sixth lens 260 may have a concave shape in respective paraxial regions thereof. The seventh lens 270 may have a positive refractive power, and both an object-side surface and an image-side surface of the seventh lens 270 may have a convex shape in respective paraxial regions thereof.

A conic constant K and aspherical surface coefficients A to H, J, and L to P according to Equation 1 discussed above of the lenses included in the optical imaging system 200 according to the second embodiment of the present disclosure are listed in Table 4 below. According to the second embodiment, both an object-side surface and an image-side surface of each of the first lens 210 to the seventh lens 270 may be aspheric surfaces.

TABLE 4

| Surface | | | | | |
|---|---|---|---|---|---|
| No. | S1 | S2 | S3 | S4 | S8 |
| K | −0.402 | 0.000 | −38.610 | −60.078 | 0.000 |
| A | −6.466E−05 | 3.727E−05 | −2.776E−06 | −3.133E−05 | 8.802E−05 |
| B | −1.595E−06 | −5.141E−07 | 1.063E−06 | −8.872E−07 | −2.050E−06 |
| C | 2.543E−09 | −5.637E−08 | −6.265E−09 | 1.046E−07 | −6.507E−06 |
| D | 0.000E+00 | 0.000E+00 | 0.000E+00 | 0.000E+00 | −2.736E−06 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Surface | | | | | |
| No. | S9 | S10 | S11 | S12 | S13 |
| K | 0.037 | −22.701 | −0.492 | −80.000 | −3.198 |
| A | −6.755E−04 | −1.479E−04 | 6.392E−03 | 1.508E−04 | 2.440E−05 |
| B | 8.050E−03 | −7.040E−05 | −1.783E−02 | −4.607E−05 | 1.855E−04 |
| C | −9.718E−03 | 7.849E−06 | 2.782E−02 | 1.837E−05 | 4.589E−05 |
| D | 6.703E−03 | 7.014E−06 | −2.660E−02 | 0.000E+00 | 0.000E+00 |
| E | −2.959E−03 | 0.000E+00 | 1.635E−02 | 0.000E+00 | 0.000E+00 |
| F | 8.310E−04 | 0.000E+00 | −6.423E−03 | 0.000E+00 | 0.000E+00 |
| G | −1.433E−04 | 0.000E+00 | 1.560E−03 | 0.000E+00 | 0.000E+00 |
| H | 1.382E−05 | 0.000E+00 | −2.131E−04 | 0.000E+00 | 0.000E+00 |
| J | −5.703E−07 | 0.000E+00 | 1.252E−05 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | |
|---|---|---|---|---|
| No. | S14 | S15 | S16 | S17 |
| K | −3.414 | −44.630 | −80.000 | −1.311 |
| A | 6.499E−04 | −1.211E−03 | 4.799E−05 | 3.778E−03 |
| B | 1.462E−05 | −2.333E−04 | −2.495E−04 | −1.966E−03 |
| C | −4.814E−05 | −6.510E−05 | −2.922E−05 | 9.042E−04 |
| D | 0.000E+00 | 0.000E+00 | 0.000E+00 | −3.607E−04 |
| E | 0.000E+00 | 0.000E+00 | 0.000E+00 | 9.403E−05 |
| F | 0.000E+00 | 0.000E+00 | 0.000E+00 | −1.475E−05 |
| G | 0.000E+00 | 0.000E+00 | 0.000E+00 | 1.227E−06 |
| H | 0.000E+00 | 0.000E+00 | 0.000E+00 | −3.602E−08 |
| J | 0.000E+00 | 0.000E+00 | 0.000E+00 | −6.667E−10 |
| L | 0.000E+00 | 0.000E+00 | 0.000E+00 | 0.000E+00 |
| M | 0.000E+00 | 0.000E+00 | 0.000E+00 | 0.000E+00 |
| N | 0.000E+00 | 0.000E+00 | 0.000E+00 | 0.000E+00 |
| O | 0.000E+00 | 0.000E+00 | 0.000E+00 | 0.000E+00 |
| P | 0.000E+00 | 0.000E+00 | 0.000E+00 | 0.000E+00 |

### Third Embodiment

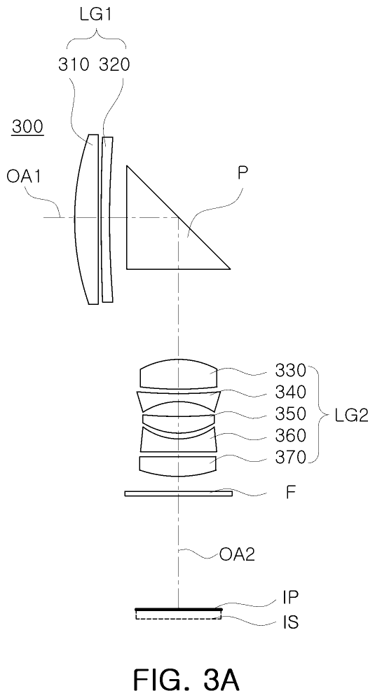

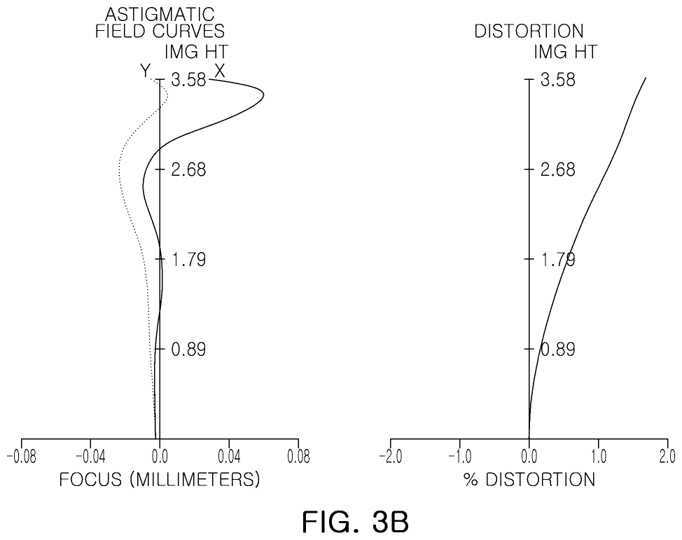

FIG. 3A is a configuration diagram illustrating an optical imaging system according to a third embodiment of the present disclosure. FIG. 3B is a graph illustrating aberration properties of the optical imaging system according to the third embodiment of the present disclosure.

Referring to FIG. 3A, an optical imaging system 300 according to the third embodiment of the present disclosure may include a first lens 310, a second lens 320, a third lens 330, a fourth lens 340, a fifth lens 350, a sixth lens 360, and a seventh lens 370 sequentially disposed in ascending numerical order along an optical axis of the optical imaging system 300 from an object side of the optical imaging system 300 toward an imaging plane IP of the optical imaging system 300. In addition, an image sensor IS having a filter F and the imaging plane IP may be disposed on an image side of the seventh lens 370. In addition, although not illustrated in the drawings, a stop may be disposed between the fifth lens 350 and the sixth lens 360.

The optical imaging system 300 according to the third embodiment of the present disclosure may include a first lens group LG1 and a second lens group LG2, and an optical path conversion member P may be disposed between the first lens group LG1 and the second lens group LG2. That is, the first lens group LG1 and the second lens group LG2 may have different optical axes.

According to the third embodiment of the present disclosure, the first lens group LG1 may include a first lens 310 and a second lens 320 sequentially disposed along a first optical axis OA1. The second lens group LG2 may include a third lens 330, a fourth lens 340, a fifth lens 350, a sixth lens 360, and a seventh lens 370 sequentially disposed along a second optical axis OA2. The optical path conversion member P may change a path of incident light from a direction of the first optical axis OA1 to a direction of the second optical axis OA2.

Properties of lenses included in the optical imaging system 300 according to the third embodiment of the present disclosure are listed in Table 5 below.

TABLE 5

| Surface | | Radius of | Thickness/ | Refractive | Abbe | Effective Radius | |
|---|---|---|---|---|---|---|---|
| No. | Element | Curvature | Distance | Index | Number | X-Axis | Y-Axis |
| S1 | First | 12.642 | 1.200 | 1.535 | 55.7 | 4.300 | 4.300 |
| S2 | Lens | −374.834 | 0.100 | | | 4.238 | 4.238 |
| S3 | Second | 77.837 | 0.400 | 1.567 | 37.4 | 4.190 | 4.190 |
| S4 | Lens | 39.478 | 0.800 | | | 4.119 | 4.119 |
| S5 | Prism | Infinity | 2.600 | 1.717 | 29.5 | | |
| S6 | | Infinity | 2.600 | 1.717 | 29.5 | | |
| S7 | | Infinity | 4.500 | | | | |
| S8 | Third | 3.957 | 1.464 | 1.535 | 55.7 | 2.400 | 1.900 |
| S9 | Len | −42.018 | 0.228 | | | 2.200 | 1.900 |
| S10 | Fourth | −46.892 | 0.401 | 1.614 | 25.9 | 2.065 | 1.900 |
| S11 | Lens | 2.968 | 0.718 | | | 1.740 | 1.740 |
| S12 | Fifth | −40.216 | 0.930 | 1.535 | 55.7 | 1.727 | 1.727 |
| S13 | Lens | −2.130 | 0.263 | | | 1.703 | 1.703 |
| S14 | Sixth | −1.982 | 0.646 | 1.567 | 37.4 | 1.746 | 1.746 |
| S15 | Lens | 54.306 | 0.270 | | | 2.109 | 1.800 |
| S16 | Seventh | 78.007 | 1.002 | 1.671 | 19.2 | 2.222 | 1.800 |
| S17 | Lens | −6.169 | 0.774 | | | 2.600 | 1.800 |
| S18 | Filter | Infinity | 0.210 | 1.517 | 64.2 | | |
| S19 | | Infinity | 5.661 | | | | |
| S20 | Imaging | Infinity | | | | | |
| | Plane | | | | | | |

According to the third embodiment of the present disclosure, the first lens 310 may have a positive refractive power, and both an object-side surface and an image-side surface of the first lens 310 may have a convex shape in respective paraxial regions thereof. The second lens 320 may have a negative refractive power, an object-side surface of the second lens 320 may have a convex shape in a paraxial region thereof, and an image-side surface of the second lens 320 may have a concave shape in a paraxial region thereof. The third lens 330 may have a positive refractive power, and both an object-side surface and an image-side surface of the third lens 330 may have a convex shape in respective paraxial regions thereof. The fourth lens 340 may have a negative refractive power, and both an object-side surface and an image-side surface of the fourth lens 340 may have a concave shape in respective paraxial regions thereof. The fifth lens 350 may have a positive refractive power, an object-side surface of the fifth lens 350 may have a concave shape in a paraxial region thereof, and an image-side surface of the fifth lens 350 may have a convex shape in a paraxial region thereof. The sixth lens 360 may have a negative refractive power, and both an object-side surface and an image-side surface of the sixth lens 360 may have a concave shape in respective paraxial regions thereof. The seventh lens 370 may have a positive refractive power, and both an object-side surface and an image-side surface of the seventh lens 370 may have a convex shape in respective paraxial regions thereof.

A conic constant K and aspherical surface coefficients A to H, J, and L to P according to Equation 1 discussed above of the lenses included in the optical imaging system 300 according to the third embodiment of the present disclosure are listed in Table 6 below. According to the third embodiment, both an object-side surface and an image-side surface of each of the first lens 310 to the seventh lens 370 may be aspheric surfaces.

TABLE 6

| Surface | | | | | |
|---|---|---|---|---|---|
| No. | S1 | S2 | S3 | S4 | S8 |
| K | −0.477 | 0.000 | −66.978 | −59.304 | 0.000 |
| A | −6.941E−05 | 3.828E−05 | −3.765E−06 | −3.280E−05 | 3.707E−05 |
| B | −1.453E−06 | −5.189E−07 | 1.213E−06 | −1.170E−06 | 7.339E−06 |
| C | 8.025E−09 | −3.574E−08 | −6.520E−09 | 9.630E−08 | −3.666E−06 |
| D | 0.000E+00 | 0.000E+00 | 0.000E+00 | 0.000E+00 | −2.576E−06 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Surface | | | | | |
| No | S9 | S10 | S11 | S12 | S13 |
| K | 0.037 | 10.000 | −0.481 | −5.796 | −3.291 |
| A | 2.095E−03 | −1.778E−04 | 2.745E−03 | −1.544E−04 | 3.952E−04 |
| B | 1.646E−03 | −7.397E−05 | −1.043E−02 | −1.104E−04 | 2.318E−04 |
| C | −2.708E−03 | 9.766E−06 | 1.987E−02 | 1.282E−05 | 4.754E−05 |
| D | 1.924E−03 | 8.276E−06 | −2.183E−02 | 0.000E+00 | 0.000E+00 |
| E | −8.588E−04 | 0.000E+00 | 1.524E−02 | 0.000E+00 | 0.000E+00 |
| F | 2.431E−04 | 0.000E+00 | −6.760E−03 | 0.000E+00 | 0.000E+00 |
| G | −4.212E−05 | 0.000E+00 | 1.847E−03 | 0.000E+00 | 0.000E+00 |
| H | 4.075E−06 | 0.000E+00 | −2.833E−04 | 0.000E+00 | 0.000E+00 |
| J | −1.687E−07 | 0.000E+00 | 1.866E−05 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | |
|---|---|---|---|---|
| No. | S14 | S15 | S16 | S17 |
| K | −3.414 | −63.191 | −80.000 | −1.126 |
| A | 7.737E−04 | −1.389E−03 | 6.575E−05 | 2.646E−03 |
| B | 5.896E−05 | −2.363E−04 | −2.552E−04 | −7.541E−04 |
| C | −4.913E−05 | −6.335E−05 | −3.064E−05 | 4.525E−05 |
| D | 0.000E+00 | 0.000E+00 | 0.000E+00 | 4.660E−05 |
| E | 0.000E+00 | 0.000E+00 | 0.000E+00 | −2.966E−05 |
| F | 0.000E+00 | 0.000E+00 | 0.000E+00 | 8.549E−06 |
| G | 0.000E+00 | 0.000E+00 | 0.000E+00 | −1.366E−06 |
| H | 0.000E+00 | 0.000E+00 | 0.000E+00 | 1.162E−07 |
| J | 0.000E+00 | 0.000E+00 | 0.000E+00 | −4.113E−09 |
| L | 0.000E+00 | 0.000E+00 | 0.000E+00 | 0.000E+00 |
| M | 0.000E+00 | 0.000E+00 | 0.000E+00 | 0.000E+00 |
| N | 0.000E+00 | 0.000E+00 | 0.000E+00 | 0.000E+00 |
| O | 0.000E+00 | 0.000E+00 | 0.000E+00 | 0.000E+00 |
| P | 0.000E+00 | 0.000E+00 | 0.000E+00 | 0.000E+00 |

### Fourth Embodiment

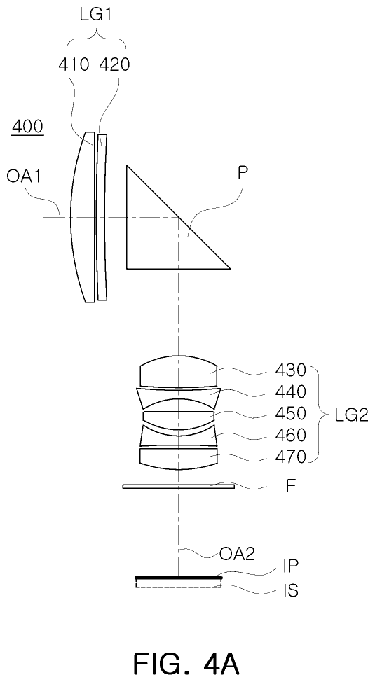

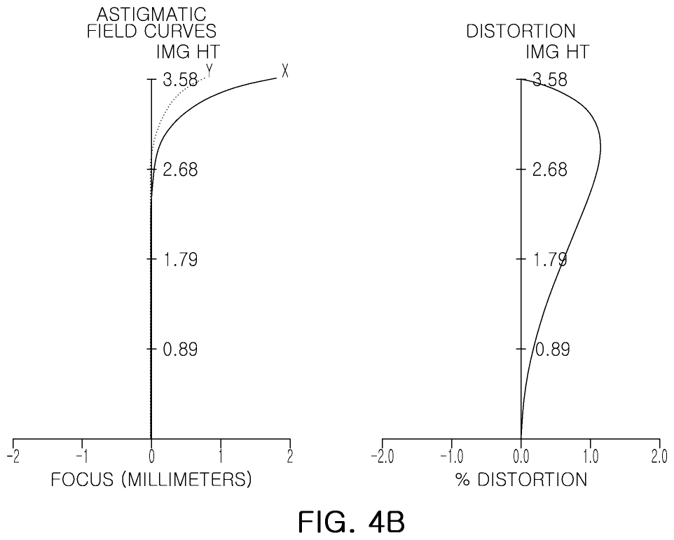

FIG. 4A is a configuration diagram illustrating an optical imaging system according to a fourth embodiment of the present disclosure. FIG. 4B is a graph illustrating aberration properties of the optical imaging system according to the fourth embodiment of the present disclosure.

Referring to FIG. 4A, an optical imaging system 400 according to the fourth embodiment of the present disclosure may include a first lens 410, a second lens 420, a third lens 430, a fourth lens 440, a fifth lens 450, a sixth lens 460, and a seventh lens 470 sequentially disposed in ascending numerical order along an optical axis of the optical imaging system 400 from an object side of the optical imaging system 400 toward an imaging plane IP of the optical imaging system 400. In addition, an image sensor IS having a filter F and the imaging plane IP may be disposed on an image side of the seventh lens 470. In addition, although not illustrated in the drawings, a stop may be disposed between the fifth lens 450 and the sixth lens 460.

The optical imaging system 400 according to the fourth embodiment of the present disclosure may include a first lens group LG1 and a second lens group LG2, and an optical path conversion member P may be disposed between the first lens group LG1 and the second lens group LG2. That is, the first lens group LG1 and the second lens group LG2 may have different optical axes.

According to the fourth embodiment of the present disclosure, the first lens group LG1 may include a first lens 410 and a second lens 420 sequentially disposed along a first optical axis OA1. The second lens group LG2 may include a third lens 430, a fourth lens 440, a fifth lens 450, a sixth lens 460, and a seventh lens 470 sequentially disposed along a second optical axis OA2. The optical path conversion member P may change a path of incident light from a direction of the first optical axis OA1 to a direction of the second optical axis OA2.

Properties of lenses included in the optical imaging system 400 according to the fourth embodiment of the present disclosure are listed in Table 7 below.

TABLE 7

| Surface | | Radius of | Thickness/ | Refractive | Abbe | Effective Radius | |
|---|---|---|---|---|---|---|---|
| No. | Element | Curvature | Distance | Index | Number | X-Axis | Y-Axis |
| S1 | First | 11.137 | 1.200 | 1.535 | 55.7 | 4.300 | 4.300 |
| S2 | Lens | −551.317 | 0.100 | | | 4.246 | 4.246 |
| S3 | Second | 178.744 | 0.400 | 1.567 | 37.4 | 4.214 | 4.214 |
| S4 | Lens | 36.340 | 1.000 | | | 4.148 | 4.148 |
| S5 | Prism | Infinity | 2.600 | 1.717 | 29.5 | | |
| S6 | | Infinity | 2.600 | 1.717 | 29.5 | | |
| S7 | | Infinity | 4.500 | | | | |
| S8 | Third | 3.743 | 1.587 | 1.535 | 55.7 | 2.400 | 1.900 |
| S9 | Len | −24.942 | 0.127 | | | 2.178 | 1.900 |
| S10 | Fourth | −20.432 | 0.435 | 1.614 | 25.9 | 2.104 | 1.900 |
| S11 | Lens | 2.973 | 0.665 | | | 1.743 | 1.743 |
| S12 | Fifth | −169.653 | 0.935 | 1.535 | 55.7 | 1.726 | 1.726 |
| S13 | Lens | −2.100 | 0.328 | | | 1.677 | 1.677 |
| S14 | Sixth | −1.888 | 0.450 | 1.567 | 37.4 | 1.745 | 1.745 |
| S15 | Lens | 12.893 | 0.177 | | | 2.148 | 1.800 |
| S16 | Seventh | 28.563 | 1.035 | 1.661 | 20.4 | 2.221 | 1.800 |
| S17 | Lens | −4.972 | 0.774 | | | 2.600 | 1.800 |
| S18 | Filter | Infinity | 0.210 | 1.517 | 64.2 | | |
| S19 | | Infinity | 4.588 | | | | |
| S20 | Imaging | Infinity | | | | | |
| | Plane | | | | | | |

According to the fourth embodiment of the present disclosure, the first lens 410 may have a positive refractive power, and both an object-side surface and an image-side surface of the first lens 410 may have a convex shape in respective paraxial regions thereof. The second lens 420 may have a negative refractive power, an object-side surface of the second lens 420 may have a convex shape in a paraxial region thereof, and an image-side surface of the second lens 420 may have a concave shape in a paraxial region thereof. The third lens 430 may have a positive refractive power, and both an object-side surface and an image-side surface of the third lens 430 may have a convex shape in respective paraxial regions thereof. The fourth lens 440 may have a negative refractive power, and both an object-side surface and an image-side surface of the fourth lens 440 may have a concave shape in respective paraxial regions thereof. The fifth lens 450 may have a positive refractive power, an object-side surface of the fifth lens 450 may have a concave shape in a paraxial region thereof, and an image-side surface of the fifth lens 450 may have a convex shape in a paraxial region thereof. The sixth lens 460 may have a negative refractive power, and both an object-side surface and an image-side surface of the sixth lens 460 may have a concave shape in respective paraxial regions thereof. The seventh lens 470 may have a positive refractive power, and both an object-side surface and an image-side surface of the seventh lens 470 may have a convex shape in respective paraxial regions thereof.

A conic constant K and aspherical surface coefficients A to H, J, and L to P according to Equation 1 discussed above of the lenses included in the optical imaging system 400 according to the fourth embodiment of the present disclosure are listed in Table 8 below. According to the fourth embodiment, both an object-side surface and an image-side surface of each of the first lens 410 to the seventh lens 470 may be aspheric surfaces.

TABLE 8

| Surface | | | | | |
|---|---|---|---|---|---|
| No. | S1 | S2 | S3 | S4 | S8 |
| K | −1.014 | −80.000 | −80.000 | −66.772 | 0.000 |
| A | −1.288E−04 | 4.450E−06 | −9.817E−06 | −1.082E−04 | −2.838E−04 |
| B | −2.766E−06 | −2.614E−07 | −3.878E−07 | −5.736E−06 | −1.303E−06 |
| C | −9.790E−08 | −1.754E−08 | −2.331E−08 | −3.565E−08 | −2.085E−06 |
| D | 0.000E+00 | −4.511E−10 | −1.195E−09 | 0.000E+00 | −4.302E−06 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |
| Surface | | | | | |
| No. | S9 | S10 | S11 | S12 | S13 |
| K | 0.037 | −5.517 | −0.489 | 10.000 | −3.470 |
| A | 3.162E−03 | −3.023E−04 | 1.703E−04 | −2.396E−04 | 1.842E−03 |
| B | 1.915E−04 | −9.849E−05 | −4.870E−03 | 5.872E−05 | 7.080E−04 |
| C | −7.014E−04 | 8.668E−06 | 7.637E−03 | 1.834E−04 | 1.513E−04 |
| D | 2.489E−04 | 9.976E−06 | −7.493E−03 | 0.000E+00 | 0.000E+00 |
| E | −7.305E−05 | 0.000E+00 | 5.162E−03 | 0.000E+00 | 0.000E+00 |
| F | 2.309E−05 | 0.000E+00 | −2.352E−03 | 0.000E+00 | 0.000E+00 |
| G | −5.380E−06 | 0.000E+00 | 6.718E−04 | 0.000E+00 | 0.000E+00 |
| H | 7.046E−07 | 0.000E+00 | −1.083E−04 | 0.000E+00 | 0.000E+00 |
| J | −3.817E−08 | 0.000E+00 | 7.501E−06 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | |
|---|---|---|---|---|
| No. | S14 | S15 | S16 | S17 |
| K | −3.638 | −43.001 | −59.376 | −1.385 |
| A | 1.192E−03 | −1.581E−03 | −2.580E−05 | 5.183E−03 |
| B | 9.537E−05 | −2.593E−04 | −2.925E−04 | −2.436E−03 |
| C | −9.477E−05 | −5.670E−05 | −4.340E−05 | 1.084E−03 |
| D | 0.000E+00 | 0.000E+00 | 0.000E+00 | −4.564E−04 |
| E | 0.000E+00 | 0.000E+00 | 0.000E+00 | 1.337E−04 |
| F | 0.000E+00 | 0.000E+00 | 0.000E+00 | −2.608E−05 |
| G | 0.000E+00 | 0.000E+00 | 0.000E+00 | 3.211E−06 |
| H | 0.000E+00 | 0.000E+00 | 0.000E+00 | −2.255E−07 |
| J | 0.000E+00 | 0.000E+00 | 0.000E+00 | 6.871E−09 |
| L | 0.000E+00 | 0.000E+00 | 0.000E+00 | 0.000E+00 |
| M | 0.000E+00 | 0.000E+00 | 0.000E+00 | 0.000E+00 |
| N | 0.000E+00 | 0.000E+00 | 0.000E+00 | 0.000E+00 |
| O | 0.000E+00 | 0.000E+00 | 0.000E+00 | 0.000E+00 |
| P | 0.000E+00 | 0.000E+00 | 0.000E+00 | 0.000E+00 |

### Fifth Embodiment

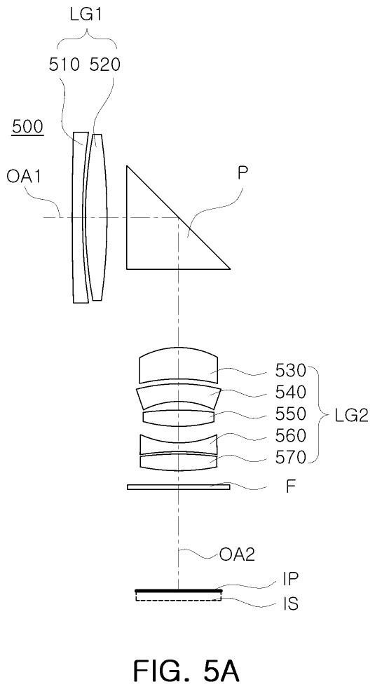

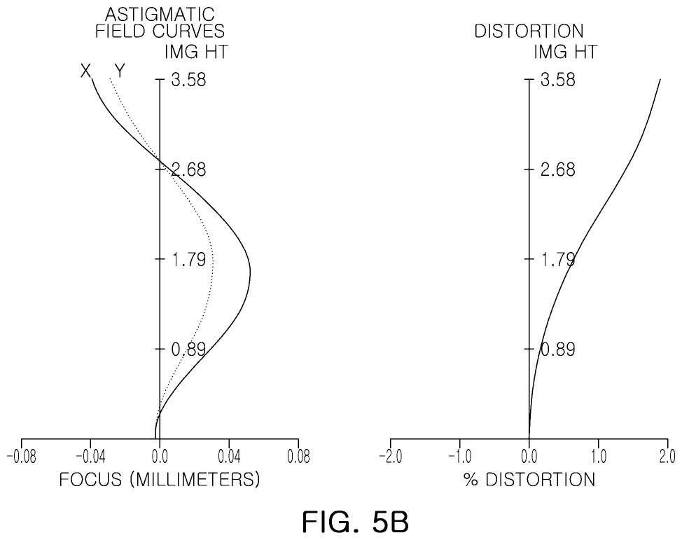

FIG. 5A is a configuration diagram illustrating an optical imaging system according to a fifth embodiment of the present disclosure. FIG. 5B is a graph illustrating aberration properties of the optical imaging system according to the fifth embodiment of the present disclosure.

Referring to FIG. 5A, an optical imaging system 500 according to the fifth embodiment of the present disclosure may include a first lens 510, a second lens 520, a third lens 530, a fourth lens 540, a fifth lens 550, a sixth lens 560, and a seventh lens 570 sequentially disposed in ascending numerical order along an optical axis of the optical imaging system 500 from an object side of the optical imaging system 500 toward an imaging plane IP of the optical imaging system 500. In addition, an image sensor IS having a filter F and the imaging plane IP may be disposed on an image side of the seventh lens 570. In addition, although not illustrated in the drawings, a stop may be disposed between the fifth lens 550 and the sixth lens 560.

The optical imaging system 500 according to the fifth embodiment of the present disclosure may include a first lens group LG1 and a second lens group LG2, and an optical path conversion member P may be disposed between the first lens group LG1 and the second lens group LG2. That is, the first lens group LG1 and the second lens group LG2 may have different optical axes.

According to the fifth embodiment of the present disclosure, the first lens group LG1 may include a first lens 510 and a second lens 520 sequentially disposed along a first optical axis OA1. The second lens group LG2 may include a third lens 530, a fourth lens 540, a fifth lens 550, a sixth lens 560, and a seventh lens 570 sequentially disposed along a second optical axis OA2. The optical path conversion member P may change a path of incident light from a direction of the first optical axis OA1 to a direction of the second optical axis OA2.

Properties of lenses included in the optical imaging system 500 according to the fifth embodiment of the present disclosure are listed in Table 9 below.

TABLE 9

| Surface | | Radius of | Thickness/ | Refractive | Abbe | Effective Radius | |
|---|---|---|---|---|---|---|---|
| No. | Element | Curvature | Distance | Index | Number | X-Axis | Y-Axis |
| S1 | First | 76.723 | 0.536 | 1.614 | 25.9 | 4.300 | 4.300 |
| S2 | Lens | 24.987 | 0.100 | | | 4.237 | 4.237 |
| S3 | Second | 19.994 | 1.064 | 1.535 | 55.7 | 4.224 | 4.224 |
| S4 | Lens | −35.926 | 1.000 | | | 4.176 | 4.176 |
| S5 | Prism | Infinity | 2.600 | 1.717 | 29.5 | | |
| S6 | | Infinity | 2.600 | 1.717 | 29.5 | | |
| S7 | | Infinity | 4.000 | | | | |
| S8 | Third | 4.118 | 1.656 | 1.535 | 55.7 | 2.400 | 1.900 |
| S9 | Len | 11.881 | 0.191 | | | 2.106 | 1.900 |
| S10 | Fourth | 10.210 | 0.862 | 1.614 | 25.9 | 2.034 | 1.900 |
| S11 | Lens | 3.286 | 0.431 | | | 1.712 | 1.712 |
| S12 | Fifth | 11.557 | 0.828 | 1.535 | 55.7 | 1.737 | 1.737 |
| S13 | Lens | −4.812 | 0.872 | | | 1.621 | 1.621 |
| S14 | Sixth | −4.138 | 0.450 | 1.567 | 37.4 | 1.865 | 1.865 |
| S15 | Lens | 8.236 | 0.164 | | | 2.116 | 1.800 |
| S16 | Seventh | 21.790 | 0.702 | 1.661 | 20.4 | 2.152 | 1.800 |
| S17 | Lens | −11.922 | 0.778 | | | 2.269 | 1.800 |
| S18 | Filter | Infinity | 0.210 | 1.517 | 64.2 | | |
| S19 | | Infinity | 5.160 | | | | |
| S20 | Imaging | Infinity | | | | | |
| | Plane | | | | | | |

According to the fifth embodiment of the present disclosure, the first lens 510 may have a negative refractive power, an object-side surface of the first lens 510 may have a convex shape in a paraxial region thereof, and an image-side surface of the first lens 510 may have a concave shape in a paraxial region thereof. The second lens 520 may have a positive refractive power, and both an object-side surface and an image-side surface of the second lens 520 may have a convex shape in respective paraxial regions thereof. The third lens 530 may have a positive refractive power, an object-side surface of the third lens 530 may have a convex shape in a paraxial region thereof, and an image-side surface of the third lens 530 may have a concave shape in a paraxial region thereof. The fourth lens 540 may have a negative refractive power, an object-side surface of the fourth lens 540 may have a convex shape in a paraxial region thereof, and an image-side surface of the fourth lens 540 may have a concave shape in a paraxial region thereof. The fifth lens 550 may have a positive refractive power, and both an object-side surface and an image-side surface of the fifth lens 550 may have a convex shape in respective paraxial regions thereof. The sixth lens 560 may have a negative refractive power, and both an object-side surface and an image-side surface of the sixth lens 560 may have a concave shape in respective paraxial regions thereof. The seventh lens 570 may have a positive refractive power, and both an object-side surface and an image-side surface of the seventh lens 570 may have a convex shape in respective paraxial regions thereof.

A conic constant K and aspherical surface coefficients A to H, J, and L to P according to Equation 1 discussed above of the lenses included in the optical imaging system 500 according to the fifth embodiment of the present disclosure are listed in Table 10 below. According to the fifth embodiment, both an object-side surface and an image-side surface of each of the first lens 510 to the seventh lens 570 may be aspheric surfaces.

TABLE 10

| Surface | | | | | |
|---|---|---|---|---|---|
| No. | S1 | S2 | S3 | S4 | S8 |
| K | −80.000 | −37.812 | −25.683 | 10.000 | 0.000 |
| A | −7.361E−05 | −4.581E−05 | 1.135E−05 | 8.310E−05 | 1.870E−04 |
| B | −2.789E−06 | −1.443E−06 | 1.502E−06 | 5.057E−07 | 3.794E−05 |
| C | 5.728E−09 | 1.179E−07 | 1.402E−07 | 1.839E−08 | 4.738E−06 |
| D | 2.178E−10 | 0.000E+00 | 4.502E−10 | 0.000E+00 | −2.367E−06 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | | |
|---|---|---|---|---|---|
| No. | S9 | S10 | S11 | S12 | S13 |
| K | 0.037 | 7.122 | −0.505 | −31.240 | −4.552 |
| A | 1.562E−03 | −3.231E−04 | −2.006E−03 | −1.775E−05 | 3.126E−03 |
| B | −1.084E−03 | −1.731E−04 | 3.357E−03 | 2.402E−04 | 9.317E−04 |
| C | 1.155E−03 | −2.390E−05 | −6.785E−03 | 3.207E−04 | 5.850E−05 |
| D | −6.535E−04 | 3.129E−06 | 7.319E−03 | 0.000E+00 | 0.000E+00 |
| E | 1.703E−04 | 0.000E+00 | −4.768E−03 | 0.000E+00 | 0.000E+00 |
| F | −1.179E−05 | 0.000E+00 | 1.973E−03 | 0.000E+00 | 0.000E+00 |
| G | −4.369E−06 | 0.000E+00 | −5.017E−04 | 0.000E+00 | 0.000E+00 |
| H | 1.059E−06 | 0.000E+00 | 7.133E−05 | 0.000E+00 | 0.000E+00 |
| J | −7.099E−08 | 0.000E+00 | −4.334E−06 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | |
|---|---|---|---|---|
| No. | S14 | S15 | S16 | S17 |
| K | −3.824 | −44.277 | −65.542 | −1.370 |
| A | 1.130E−03 | −1.617E−03 | 1.710E−04 | 6.067E−03 |
| B | −2.881E−04 | −3.017E−04 | −2.928E−04 | −3.708E−03 |
| C | −2.623E−04 | −6.066E−05 | −7.033E−05 | 2.838E−03 |
| D | 0.000E+00 | 0.000E+00 | 0.000E+00 | −1.760E−03 |
| E | 0.000E+00 | 0.000E+00 | 0.000E+00 | 6.882E−04 |
| F | 0.000E+00 | 0.000E+00 | 0.000E+00 | −1.698E−04 |
| G | 0.000E+00 | 0.000E+00 | 0.000E+00 | 2.566E−05 |
| H | 0.000E+00 | 0.000E+00 | 0.000E+00 | −2.166E−06 |
| J | 0.000E+00 | 0.000E+00 | 0.000E+00 | 7.821E−08 |
| L | 0.000E+00 | 0.000E+00 | 0.000E+00 | 0.000E+00 |
| M | 0.000E+00 | 0.000E+00 | 0.000E+00 | 0.000E+00 |
| N | 0.000E+00 | 0.000E+00 | 0.000E+00 | 0.000E+00 |
| O | 0.000E+00 | 0.000E+00 | 0.000E+00 | 0.000E+00 |
| P | 0.000E+00 | 0.000E+00 | 0.000E+00 | 0.000E+00 |

### Sixth Embodiment

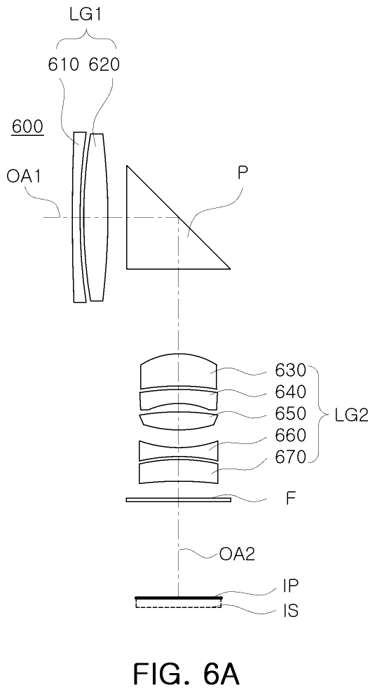

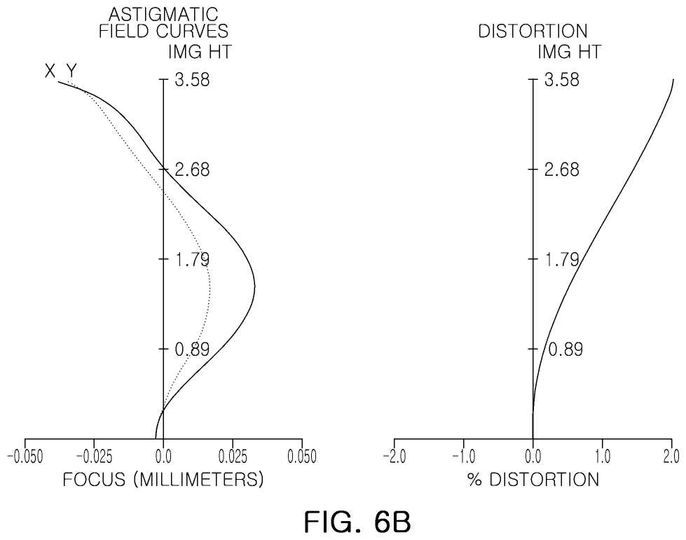

FIG. 6A is a configuration diagram illustrating an optical imaging system according to a sixth embodiment of the present disclosure. FIG. 6B is a graph illustrating aberration properties of the optical imaging system according to the sixth embodiment of the present disclosure.

Referring to FIG. 6A, an optical imaging system 600 according to the sixth embodiment of the present disclosure may include a first lens 610, a second lens 620, a third lens 630, a fourth lens 640, a fifth lens 650, a sixth lens 660, and a seventh lens 670 sequentially disposed in ascending numerical order along an optical axis of the optical imaging system 600 from an object side of the optical imaging system 600 toward an imaging plane IP of the optical imaging system 600. In addition, an image sensor IS having a filter F and the imaging plane IP may be disposed on an image side of the seventh lens 670. In addition, although not illustrated in the drawings, a stop may be disposed between the fifth lens 650 and the sixth lens 660.

The optical imaging system 600 according to the sixth embodiment of the present disclosure may include a first lens group LG1 and a second lens group LG2, and an optical path conversion member P may be disposed between the first lens group LG1 and the second lens group LG2. That is, the first lens group LG1 and the second lens group LG2 may have different optical axes.

According to the sixth embodiment of the present disclosure, the first lens group LG1 may include a first lens 610 and a second lens 620 sequentially disposed along a first optical axis OA1. The second lens group LG2 may include a third lens 630, a fourth lens 640, a fifth lens 650, a sixth lens 660, and a seventh lens 670 sequentially disposed along a second optical axis OA2. The optical path conversion member P may change a path of incident light from a direction of the first optical axis OA1 to a direction of the second optical axis OA2.

Properties of lenses included in the optical imaging system 600 according to the sixth embodiment of the present disclosure are listed in Table 11 below.

TABLE 11

| Surface | | Radius of | Thickness/ | Refractive | Abbe | Effective Radius | |
|---|---|---|---|---|---|---|---|
| No. | Element | Curvature | Distance | Index | Number | X-Axis | Y-Axis |
| S1 | First | 75.703 | 0.409 | 1.614 | 25.9 | 4.300 | 4.300 |
| S2 | Lens | 24.892 | 0.100 | | | 4.247 | 4.247 |
| S3 | Second | 19.807 | 1.191 | 1.535 | 55.7 | 4.235 | 4.235 |
| S4 | Lens | −36.572 | 1.000 | | | 4.176 | 4.176 |
| S5 | Prism | Infinity | 2.600 | 1.717 | 29.5 | | |
| S6 | | Infinity | 2.600 | 1.717 | 29.5 | | |
| S7 | | Infinity | 4.467 | | | | |
| S8 | Third | 4.267 | 1.531 | 1.535 | 55.7 | 2.400 | 1.900 |
| S9 | Len | 11.437 | 0.100 | | | 2.106 | 1.900 |
| S10 | Fourth | 9.562 | 0.744 | 1.614 | 25.9 | 2.034 | 1.900 |
| S11 | Lens | 3.590 | 0.421 | | | 1.712 | 1.712 |
| S12 | Fifth | 11.501 | 0.906 | 1.535 | 55.7 | 1.737 | 1.737 |
| S13 | Lens | −4.635 | 0.922 | | | 1.621 | 1.621 |
| S14 | Sixth | −3.591 | 0.459 | 1.567 | 37.4 | 1.865 | 1.865 |
| S15 | Lens | 9.447 | 0.100 | | | 2.116 | 1.800 |
| S16 | Seventh | 7.611 | 1.200 | 1.661 | 20.4 | 2.152 | 1.800 |
| S17 | Lens | 80.710 | 0.777 | | | 2.269 | 1.800 |
| S18 | Filter | Infinity | 0.210 | 1.517 | 64.2 | | |
| S19 | | Infinity | 4.825 | | | | |
| S20 | Imaging | Infinity | | | | | |
| | Plane | | | | | | |

According to the sixth embodiment of the present disclosure, the first lens 610 may have a negative refractive power, an object-side surface of the first lens 610 may have a convex shape in a paraxial region thereof, and an image-side surface of the first lens 610 may have a concave shape in a paraxial region thereof. The second lens 620 may have a positive refractive power, and both an object-side surface and an image-side surface of the second lens 620 may have a convex shape in respective paraxial regions thereof. The third lens 630 may have a positive refractive power, an object-side surface of the third lens 630 may have a convex shape in a paraxial region thereof, and an image-side surface of the third lens 630 may have a concave shape in a paraxial region thereof. The fourth lens 640 may have a negative refractive power, an object-side surface of the fourth lens 640 may have a convex shape in a paraxial region thereof, and an image-side surface of the fourth lens 640 may have a concave shape in a paraxial region thereof. The fifth lens 650 may have a positive refractive power, and both an object-side surface and an image-side surface of the fifth lens 650 may have a convex shape in respective paraxial regions thereof. The sixth lens 660 may have a negative refractive power, and both an object-side surface and an image-side surface of the sixth lens 660 may have a concave shape in respective paraxial regions thereof. The seventh lens 670 may have a positive refractive power, an object-side surface of the seventh lens 670 may have a convex shape in a paraxial region thereof, and an image-side surface of the seventh lens 670 may have a concave shape in a paraxial region thereof.

A conic constant K and aspherical surface coefficients A to H, J, and L to P according to Equation 1 discussed above of the lenses included in the optical imaging system 600 according to the sixth embodiment of the present disclosure are listed in Table 12 below. According to the sixth embodiment, both an object-side surface and an image-side surface of each of the first lens 610 to the seventh lens 670 may be aspheric surfaces.

TABLE 12

| Surface | | | | | |
|---|---|---|---|---|---|
| No. | S1 | S2 | S3 | S4 | S8 |
| K | −80.000 | −35.589 | −24.091 | 10.000 | 0.000 |
| A | −8.286E−05 | −3.675E−05 | 1.928E−05 | 6.679E−05 | 3.147E−05 |
| B | −2.953E−06 | −1.052E−06 | 1.508E−06 | 1.501E−07 | 2.263E−05 |
| C | 1.097E−08 | 1.265E−07 | 1.336E−07 | 2.942E−08 | 6.089E−06 |
| D | 6.633E−10 | 0.000E+00 | 3.556E−10 | 0.000E+00 | −1.140E−06 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | | |
|---|---|---|---|---|---|
| No. | S9 | S10 | S11 | S12 | S13 |
| K | 0.037 | 6.202 | −0.400 | −25.758 | −3.832 |
| A | 6.887E−04 | −5.418E−04 | −3.186E−04 | 2.832E−04 | 2.503E−03 |
| B | −2.721E−03 | −1.987E−04 | 2.817E−03 | 2.441E−04 | 8.512E−04 |
| C | 3.982E−03 | −1.862E−05 | −6.712E−03 | 2.656E−04 | 8.437E−05 |
| D | −2.987E−03 | 7.942E−06 | 6.968E−03 | 0.000E+00 | 0.000E+00 |
| E | 1.350E−03 | 0.000E+00 | −4.293E−03 | 0.000E+00 | 0.000E+00 |
| F | −3.815E−04 | 0.000E+00 | 1.655E−03 | 0.000E+00 | 0.000E+00 |
| G | 6.588E−05 | 0.000E+00 | −3.886E−04 | 0.000E+00 | 0.000E+00 |
| H | −6.355E−06 | 0.000E+00 | 5.075E−05 | 0.000E+00 | 0.000E+00 |
| J | 2.622E−07 | 0.000E+00 | −2.824E−06 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | |
|---|---|---|---|---|
| No. | S14 | S15 | S16 | S17 |
| K | −5.869 | 0.000 | 4.427 | −1.370 |
| A | 2.490E−03 | 0.000E+00 | −6.384E−04 | 6.602E−03 |
| B | −2.795E−04 | 0.000E+00 | −2.841E−04 | −1.532E−03 |
| C | −9.486E−05 | 0.000E+00 | −3.050E−05 | 1.154E−04 |
| D | 0.000E+00 | 0.000E+00 | −3.335E−08 | 8.919E−05 |
| E | 0.000E+00 | 0.000E+00 | 0.000E+00 | −7.089E−05 |
| F | 0.000E+00 | 0.000E+00 | 0.000E+00 | 2.347E−05 |
| G | 0.000E+00 | 0.000E+00 | 0.000E+00 | −4.149E−06 |
| H | 0.000E+00 | 0.000E+00 | 0.000E+00 | 3.824E−07 |
| J | 0.000E+00 | 0.000E+00 | 0.000E+00 | −1.445E−08 |
| L | 0.000E+00 | 0.000E+00 | 0.000E+00 | 0.000E+00 |
| M | 0.000E+00 | 0.000E+00 | 0.000E+00 | 0.000E+00 |
| N | 0.000E+00 | 0.000E+00 | 0.000E+00 | 0.000E+00 |
| O | 0.000E+00 | 0.000E+00 | 0.000E+00 | 0.000E+00 |
| P | 0.000E+00 | 0.000E+00 | 0.000E+00 | 0.000E+00 |

### Seventh Embodiment

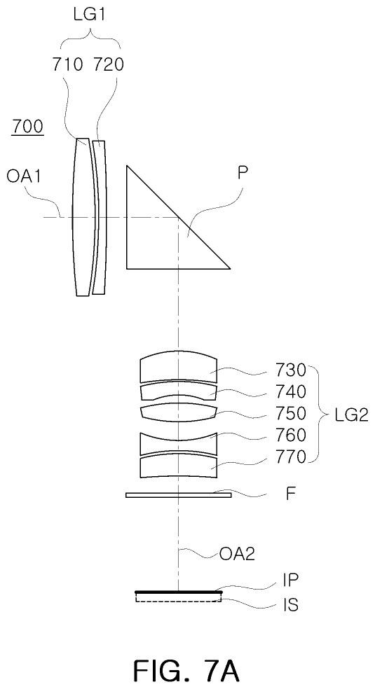

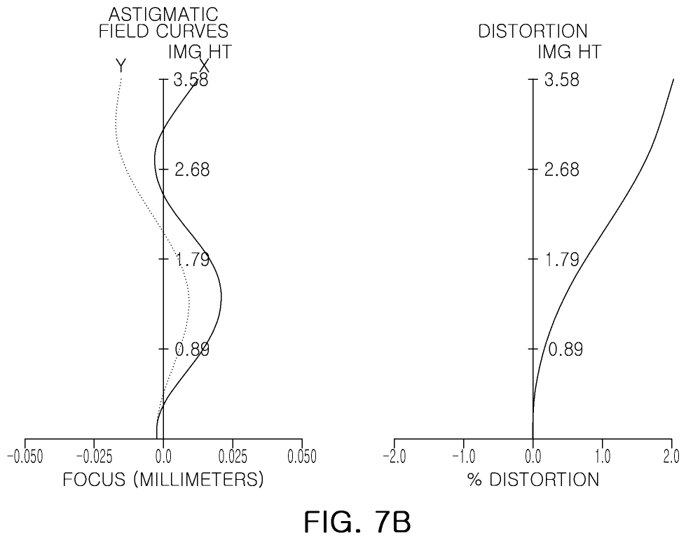

FIG. 7A is a configuration diagram illustrating an optical imaging system according to a seventh embodiment of the present disclosure. FIG. 7B is a graph illustrating aberration properties of the optical imaging system according to the seventh embodiment of the present disclosure.

Referring to FIG. 7A, an optical imaging system 700 according to the seventh embodiment of the present disclosure may include a first lens 710, a second lens 720, a third lens 730, a fourth lens 740, a fifth lens 750, a sixth lens 760, and a seventh lens 770 sequentially disposed in ascending numerical order along an optical axis of the optical imaging system 700 from an object side of the optical imaging system 700 toward an imaging plane IP of the optical imaging system 700. In addition, an image sensor IS having a filter F and the imaging plane IP may be disposed on an image side of the seventh lens 770. In addition, although not illustrated in the drawings, a stop may be disposed between the fifth lens 750 and the sixth lens 760.

The optical imaging system 700 according to the seventh embodiment of the present disclosure may include a first lens group LG1 and a second lens group LG2, and an optical path conversion member P may be disposed between the first lens group LG1 and the second lens group LG2. That is, the first lens group LG1 and the second lens group LG2 may have different optical axes.

According to the seventh embodiment of the present disclosure, the first lens group LG1 may include a first lens 710 and a second lens 720 sequentially disposed along a first optical axis OA1. The second lens group LG2 may include a third lens 730, a fourth lens 740, a fifth lens 750, a sixth lens 760, and a seventh lens 770 sequentially disposed along a second optical axis OA2. The optical path conversion member P may change a path of incident light from a direction of the first optical axis OA1 to a direction of the second optical axis OA2.

Properties of lenses included in the optical imaging system 700 according to the seventh embodiment of the present disclosure are listed in Table 13 below.

TABLE 13

| Surface | | Radius of | Thickness/ | Refractive | Abbe | Effective Radius | |
|---|---|---|---|---|---|---|---|
| No. | Element | Curvature | Distance | Index | Number | X-Axis | Y-Axis |
| S1 | First | 35.088 | 1.155 | 1.535 | 55.7 | 4.000 | 4.000 |
| S2 | Lens | −21.177 | 0.100 | | | 3.942 | 3.942 |
| S3 | Second | −27.332 | 0.445 | 1.614 | 25.9 | 3.898 | 3.898 |
| S4 | Lens | −87.327 | 1.000 | | | 3.837 | 3.837 |
| S5 | Prism | Infinity | 2.600 | 1.717 | 29.5 | | |
| S6 | | Infinity | 2.600 | 1.717 | 29.5 | | |
| S7 | | Infinity | 4.198 | | | | |
| S8 | Third | 4.270 | 1.470 | 1.535 | 55.7 | 2.400 | 1.900 |
| S9 | Len | 11.365 | 0.100 | | | 2.147 | 1.900 |
| S10 | Fourth | 9.490 | 0.694 | 1.614 | 25.9 | 2.108 | 1.900 |
| S11 | Lens | 3.594 | 0.429 | | | 1.846 | 1.846 |
| S12 | Fifth | 11.590 | 0.915 | 1.535 | 55.7 | 1.885 | 1.885 |
| S13 | Lens | −4.507 | 0.954 | | | 1.743 | 1.743 |
| S14 | Sixth | −3.539 | 0.529 | 1.567 | 37.4 | 1.947 | 1.947 |
| S15 | Lens | 9.143 | 0.119 | | | 2.153 | 1.800 |
| S16 | Seventh | 7.553 | 1.200 | 1.661 | 20.4 | 2.234 | 1.800 |
| S17 | Lens | 99.863 | 0.777 | | | 2.387 | 1.800 |
| S18 | Filter | Infinity | 0.210 | 1.517 | 64.2 | | |
| S19 | | Infinity | 4.794 | | | | |
| S20 | Imaging | Infinity | | | | | |
| | Plane | | | | | | |

According to the seventh embodiment of the present disclosure, the first lens 710 may have a positive refractive power, and both an object-side surface and an image-side surface of the first lens 710 may have a convex shape in respective paraxial regions thereof. The second lens 720 may have a negative refractive power, an object-side surface of the second lens 720 may have a concave shape in a paraxial region thereof, and an image-side surface of the second lens 720 may have a convex shape in a paraxial region thereof. The third lens 730 may have a positive refractive power, an object-side surface of the third lens 730 may have a convex shape in a paraxial region thereof, and an image-side surface of the third lens 730 may have a concave shape in a paraxial region thereof. The fourth lens 740 may have a negative refractive power, an object-side surface of the fourth lens 740 may have a convex shape in a paraxial region thereof, and an image-side surface of the fourth lens 740 may have a concave shape in a paraxial region thereof. The fifth lens 750 may have a positive refractive power, and both an object-side surface and an image-side surface of the fifth lens 750 may have a convex shape in respective paraxial regions thereof. The sixth lens 760 may have a negative refractive power, and both an object-side surface and an image-side surface of the sixth lens 760 may have a concave shape in respective paraxial regions thereof. The seventh lens 770 may have a positive refractive power, an object-side surface of the seventh lens 770 may have a convex shape in a paraxial region thereof, and an image-side surface of the seventh lens 770 may have a concave shape in a paraxial region thereof.

A conic constant K and aspherical surface coefficients A to H, J, and L to P according to Equation 1 discussed above of the lenses included in the optical imaging system 700 according to the seventh embodiment of the present disclosure are listed in Table 14 below. According to the seventh embodiment, both an object-side surface and an image-side surface of each of the first lens 710 to the seventh lens 770 may be aspheric surfaces.

TABLE 14

| Surface | | | | | |
|---|---|---|---|---|---|
| No. | S1 | S2 | S3 | S4 | S8 |
| K | 9.665 | −24.354 | −34.533 | −80.000 | 0.000 |
| A | −6.785E−05 | −1.709E−05 | 3.227E−05 | 8.596E−05 | 2.787E−05 |
| B | −1.948E−07 | −1.275E−06 | 7.659E−07 | 2.913E−06 | 2.423E−05 |
| C | −6.335E−08 | −1.027E−07 | −1.459E−07 | −4.354E−08 | 6.342E−06 |
| D | 0.000E+00 | 2.565E−09 | 0.000E+00 | −5.515E−09 | −1.119E−06 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | | |
|---|---|---|---|---|---|
| No. | S9 | S10 | S11 | S12 | S13 |
| K | 0.037 | 6.262 | −0.409 | −25.655 | −3.877 |
| A | −1.332E−04 | −5.269E−04 | 7.223E−04 | 2.933E−04 | 2.528E−02 |
| B | −8.570E−04 | −1.966E−04 | −7.313E−04 | 2.486E−04 | 8.472E−04 |
| C | 1.779E−03 | −1.829E−05 | −1.317E−03 | 2.664E−04 | 8.362E−05 |
| D | −1.404E−03 | 7.979E−06 | 2.030E−03 | 0.000E+00 | 0.000E+00 |
| E | 6.326E−04 | 0.000E+00 | −1.441E−03 | 0.000E+00 | 0.000E+00 |
| F | −1.759E−04 | 0.000E+00 | 6.153E−04 | 0.000E+00 | 0.000E+00 |
| G | 2.983E−05 | 0.000E+00 | −1.562E−04 | 0.000E+00 | 0.000E+00 |
| H | −2.819E−06 | 0.000E+00 | 2.171E−05 | 0.000E+00 | 0.000E+00 |
| J | 1.138E−07 | 0.000E+00 | −1.271E−06 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | |
|---|---|---|---|---|
| No. | S14 | S15 | S16 | S17 |
| K | −5.778 | 0.000 | 4.370 | −1.370 |
| A | 2.447E−03 | 0.000E+00 | −6.768E−04 | 6.617E−03 |
| B | −2.630E−04 | 0.000E+00 | −2.890E−04 | −1.904E−03 |
| C | −8.063E−05 | 0.000E+00 | −3.097E−05 | 5.329E−04 |
| D | 0.000E+00 | 0.000E+00 | 8.040E−09 | −1.582E−04 |
| E | 0.000E+00 | 0.000E+00 | 0.000E+00 | 2.143E−05 |
| F | 0.000E+00 | 0.000E+00 | 0.000E+00 | 1.457E−06 |
| G | 0.000E+00 | 0.000E+00 | 0.000E+00 | −9.084E−07 |
| H | 0.000E+00 | 0.000E+00 | 0.000E+00 | 1.145E−07 |
| J | 0.000E+00 | 0.000E+00 | 0.000E+00 | −4.957E−09 |
| L | 0.000E+00 | 0.000E+00 | 0.000E+00 | 0.000E+00 |
| M | 0.000E+00 | 0.000E+00 | 0.000E+00 | 0.000E+00 |
| N | 0.000E+00 | 0.000E+00 | 0.000E+00 | 0.000E+00 |
| O | 0.000E+00 | 0.000E+00 | 0.000E+00 | 0.000E+00 |
| P | 0.000E+00 | 0.000E+00 | 0.000E+00 | 0.000E+00 |

### Eighth Embodiment

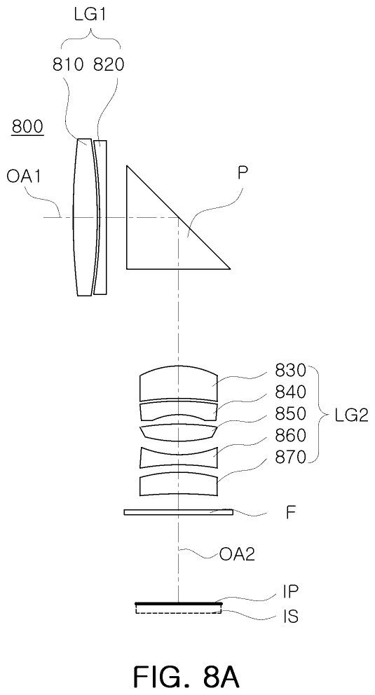

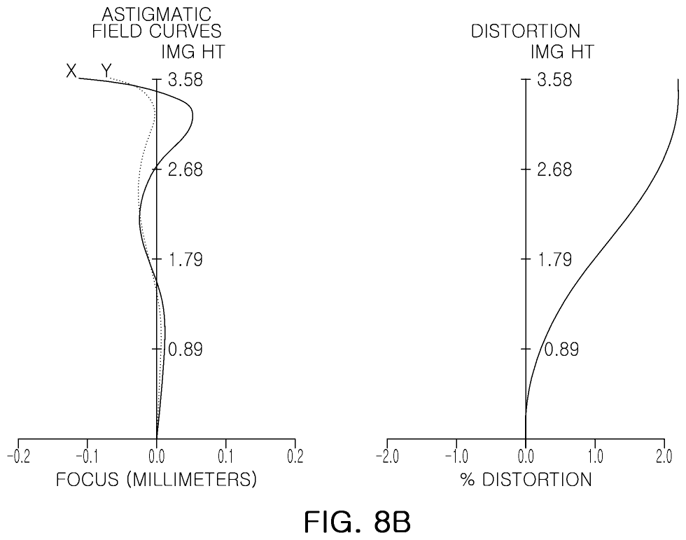

FIG. 8A is a configuration diagram illustrating an optical imaging system according to an eighth embodiment of the present disclosure. FIG. 8B is a graph illustrating aberration properties of the optical imaging system according to the eighth embodiment of the present disclosure.

Referring to FIG. 8A, an optical imaging system 800 according to the eighth embodiment of the present disclosure may include a first lens 810, a second lens 820, a third lens 830, a fourth lens 840, a fifth lens 850, a sixth lens 860, and a seventh lens 870 sequentially disposed in ascending numerical order along an optical axis of the optical imaging system 800 from an object side of the optical imaging system 800 toward an imaging plane IP of the optical imaging system 800. In addition, an image sensor IS having a filter F and the imaging plane IP may be disposed on an image side of the seventh lens 870. In addition, although not illustrated in the drawings, a stop may be disposed between the fifth lens 850 and the sixth lens 860.

The optical imaging system 800 according to the eighth embodiment of the present disclosure may include a first lens group LG1 and a second lens group LG2, and an optical path conversion member P may be disposed between the first lens group LG1 and the second lens group LG2. That is, the first lens group LG1 and the second lens group LG2 may have different optical axes.

According to the eighth embodiment of the present disclosure, the first lens group LG1 may include a first lens 810 and a second lens 820 sequentially disposed along a first optical axis OA1. The second lens group LG2 may include a third lens 830, a fourth lens 840, a fifth lens 850, a sixth lens 860, and a seventh lens 870 sequentially disposed along a second optical axis OA2. The optical path conversion member P may change a path of incident light from a direction of the first optical axis OA1 to a direction of the second optical axis OA2.

Properties of lenses included in the optical imaging system 800 according to the eighth embodiment of the present disclosure are listed in Table 15 below.

TABLE 15

| Surface | | Radius of | Thickness/ | Refractive | Abbe | Effective Radius | |
|---|---|---|---|---|---|---|---|
| No. | Element | Curvature | Distance | Index | Number | X-Axis | Y-Axis |
| S1 | First | 25.682 | 1.200 | 1.535 | 55.7 | 4.000 | 4.000 |
| S2 | Lens | −28.783 | 0.100 | | | 3.940 | 3.940 |
| S3 | Second | −37.850 | 0.400 | 1.614 | 25.9 | 3.905 | 3.905 |
| S4 | Lens | −339.270 | 1.000 | | | 3.852 | 3.852 |
| S5 | Prism | Infinity | 2.600 | 1.717 | 29.5 | | |
| S6 | | Infinity | 2.600 | 1.717 | 29.5 | | |
| S7 | | Infinity | 5.000 | | | | |
| S8 | Third | 4.177 | 1.616 | 1.535 | 55.7 | 2.400 | 1.900 |
| S9 | Len | 11.010 | 0.100 | | | 2.108 | 1.900 |
| S10 | Fourth | 9.722 | 0.747 | 1.614 | 25.9 | 2.073 | 1.900 |
| S11 | Lens | 3.541 | 0.419 | | | 1.816 | 1.816 |
| S12 | Fifth | 10.808 | 0.939 | 1.535 | 55.7 | 1.851 | 1.851 |
| S13 | Lens | −3.952 | 0.695 | | | 1.692 | 1.692 |
| S14 | Sixth | −3.208 | 0.450 | 1.567 | 37.4 | 1.890 | 1.890 |
| S15 | Lens | 9.097 | 0.388 | | | 2.088 | 1.800 |
| S16 | Seventh | 7.765 | 1.147 | 1.661 | 20.4 | 2.297 | 1.800 |
| S17 | Lens | 375.015 | 0.777 | | | 2.463 | 1.800 |
| S18 | Filter | Infinity | 0.210 | 1.517 | 64.2 | | |
| S19 | | Infinity | 4.556 | | | | |
| S20 | Imaging | Infinity | | | | | |
| | Plane | | | | | | |

According to the eighth embodiment of the present disclosure, the first lens 810 may have a positive refractive power, and both an object-side surface and an image-side surface of the first lens 810 may have a convex shape in respective paraxial regions thereof. The second lens 820 may have a negative refractive power, an object-side surface of the second lens 820 may have a concave shape in a paraxial region thereof, and an image-side surface may have a convex shape in a paraxial region thereof. The third lens 830 may have a positive refractive power, an object-side surface of the third lens 830 may have a convex shape in a paraxial region thereof, and an image-side surface of the third lens 830 may have a concave shape in a paraxial region thereof. The fourth lens 840 may have a negative refractive power, an object-side surface of the fourth lens 840 may have a convex shape in a paraxial region thereof, and an image-side surface of the fourth lens 840 may have a concave shape in a paraxial region thereof. The fifth lens 850 may have a positive refractive power, and both an object-side surface and an image-side surface of the fifth lens 850 may have a convex shape in respective paraxial regions thereof. The sixth lens 860 may have a negative refractive power, and both an object-side surface and an image-side surface of the sixth lens 860 may have a concave shape in respective paraxial regions thereof. The seventh lens 870 may have a positive refractive power, an object-side surface of the seventh lens 870 may have a convex shape in a paraxial region thereof, and an image-side surface of the seventh lens 870 may have a concave shape in a paraxial region thereof.

A conic constant K and aspherical surface coefficients A to H, J, and L to P according to Equation 1 discussed above of the lenses included in the optical imaging system 800 according to the eighth embodiment of the present disclosure are listed in Table 16 below. According to the eighth embodiment, both an object-side surface and an image-side surface of each of the first lens 810 to the seventh lens 870 may be aspheric surfaces.

TABLE 16

| Surface | | | | | |
|---|---|---|---|---|---|
| No. | S1 | S2 | S3 | S4 | S8 |
| K | 7.067 | −26.430 | −32.347 | 10.000 | 0.000 |
| A | −8.012E−05 | −1.160E−05 | 2.973E−05 | 7.163E−05 | −1.326E−06 |
| B | −9.805E−07 | −1.509E−06 | 9.679E−07 | 6.950E−07 | 3.253E−05 |
| C | −1.726E−07 | −8.117E−08 | −1.401E−07 | −1.559E−07 | 5.573E−06 |
| D | 0.000E+00 | 4.371E−09 | 0.000E+00 | −7.499E−09 | −2.186E−06 |
| E | 0.000E+00 | 0.000E+00 | 0.000E+00 | 0.000E+00 | 0.000E+00 |
| F | 0.000E+00 | 0.000E+00 | 0.000E+00 | 0.000E+00 | 0.000E+00 |
| G | 0.000E+00 | 0.000E+00 | 0.000E+00 | 0.000E+00 | 0.000E+00 |
| H | 0.000E+00 | 0.000E+00 | 0.000E+00 | 0.000E+00 | 0.000E+00 |
| J | 0.000E+00 | 0.000E+00 | 0.000E+00 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | | |
|---|---|---|---|---|---|
| No. | S9 | S10 | S11 | S12 | S13 |
| K | 0.037 | 6.114 | −0.407 | −28.923 | −4.277 |
| A | −1.759E−03 | −5.691E−04 | 2.749E−03 | 1.808E−04 | 2.776E−03 |
| B | 2.347E−03 | −2.000E−04 | −4.504E−03 | 2.473E−04 | 8.149E−04 |
| C | −1.468E−03 | −1.671E−05 | 3.044E−03 | 2.687E−04 | 7.261E−050 |
| D | 6.565E−04 | 8.961E−06 | −1.187E−03 | 0.000E+00 | 0.000E+00 |
| E | −1.994E−04 | 0.000E+00 | 6.229E−05 | 0.000E+00 | 0.000E+00 |
| F | 3.712E−05 | 0.000E+00 | 1.641E−04 | 0.000E+00 | 0.000E+00 |
| G | −3.734E−06 | 0.000E+00 | −7.080E−05 | 0.000E+00 | 0.000E+00 |
| H | 1.456E−07 | 0.000E+00 | 1.226E−05 | 0.000E+00 | 0.000E+00 |
| J | 1.513E−09 | 0.000E+00 | −7.966E−07 | 0.000E+00 | 0.000E+00 |
| L | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 |

| Surface | | | | |
|---|---|---|---|---|
| No. | S14 | S15 | S16 | S17 |
| K | −6.016 | −1.729 | 4.279 | −1.370 |
| A | 2.975E−03 | −2.707E−04 | −5.944E−04 | 7.216E−03 |
| B | −2.516E−04 | −1.003E−04 | −2.882E−04 | −2.034E−03 |
| C | −1.611E−04 | −1.278E−05 | −3.546E−05 | 6.864E−04 |
| D | 0.000E+00 | −7.054E−07 | −1.693E−06 | −2.887E−04 |
| E | 0.000E+00 | 2.138E−07 | 0.000E+00 | 8.043E−05 |
| F | 0.000E+00 | 0.000E+00 | 0.000E+00 | −1.420E−05 |
| G | 0.000E+00 | 0.000E+00 | 0.000E+00 | 1.516E−06 |
| H | 0.000E+00 | 0.000E+00 | 0.000E+00 | −8.843E−08 |
| J | 0.000E+00 | 0.000E+00 | 0.000E+00 | 2.139E−09 |
| L | 0.000E+00 | 0.000E+00 | 0.000E+00 | 0.000E+00 |
| M | 0.000E+00 | 0.000E+00 | 0.000E+00 | 0.000E+00 |
| N | 0.000E+00 | 0.000E+00 | 0.000E+00 | 0.000E+00 |
| O | 0.000E+00 | 0.000E+00 | 0.000E+00 | 0.000E+00 |
| P | 0.000E+00 | 0.000E+00 | 0.000E+00 | 0.000E+00 |

Table 17 below lists optical and physical properties of the optical imaging systems according to the first to eighth embodiments of the present disclosure. TTL in Table 17 is a distance along the optical axis from the object-side surface of the first lens to the imaging plane, but does not appear in any of Conditional Expressions 1 to 15 discussed above.

TABLE 17

| | Embodi- | Embodi- | Embodi- | Embodi- |
|---|---|---|---|---|
| Property | ment 1 | ment 2 | ment 3 | ment 4 |
| f | 18.605 | 18.176 | 17.549 | 16.007 |
| f1 | 21.745 | 22.728 | 22.892 | 20.427 |
| f2 | −151.358 | −151.357 | −141.775 | −80.503 |
| f3 | 7.548 | 8.152 | 6.838 | 6.206 |
| f4 | −4.574 | −5.187 | −4.529 | −4.194 |
| f5 | 3.892 | 3.865 | 4.169 | 3.967 |
| f6 | −2.986 | −3.060 | −3.358 | −2.872 |
| f7 | 7.433 | 8.217 | 8.564 | 6.489 |
| fG1 | 25.151 | 26.476 | 26.988 | 26.842 |
| fG2 | 38.909 | 34.230 | 27.894 | 22.123 |
| F-number | 2.700 | 2.695 | 2.603 | 2.321 |
| FOV | 21.368 | 21.865 | 22.625 | 22.744 |
| IMG HT | 3.575 | 3.575 | 3.575 | 3.575 |
| TTL | 25.022 | 24.994 | 24.768 | 23.712 |
| BFL | 8.485 | 8.270 | 7.918 | 6.784 |
| dG1G2 | 10.500 | 10.500 | 10.500 | 10.700 |
| h1 | 7.700 | 7.700 | 7.700 | 7.900 |
| h2 | 3.800 | 3.800 | 3.800 | 3.800 |
| SD1 | 8.600 | 8.600 | 8.600 | 8.600 |
| | Embodi- | Embodi- | Embodi- | Embodi- |
| Property | ment 5 | ment 6 | ment 7 | ment 8 |
| f | 16.009 | 16.011 | 16.011 | 16.013 |
| f1 | −60.543 | −60.543 | 24.872 | 25.574 |
| f2 | 24.179 | 24.203 | −64.928 | −69.369 |
| f3 | 10.971 | 11.847 | 11.926 | 11.625 |
| f4 | −8.278 | −9.822 | −9.855 | −9.503 |
| f5 | 6.467 | 6.301 | 6.191 | 5.534 |
| f6 | −4.793 | −4.530 | −4.431 | −4.126 |
| f7 | 11.760 | 12.636 | 12.303 | 11.986 |
| fG1 | 40.047 | 40.048 | 40.056 | 40.064 |
| fG2 | 25.330 | 26.076 | 25.596 | 23.669 |
| F-number | 2.815 | 2.785 | 2.776 | 2.679 |
| FOV | 24.733 | 24.702 | 24.702 | 24.676 |
| IMG HT | 3.575 | 3.575 | 3.575 | 3.575 |
| TTL | 24.203 | 24.563 | 24.289 | 24.944 |
| BFL | 7.014 | 7.113 | 7.100 | 7.078 |
| dG1G2 | 10.200 | 10.667 | 10.398 | 11.200 |
| h1 | 7.900 | 7.900 | 7.900 | 7.900 |
| h2 | 3.800 | 3.800 | 3.800 | 3.800 |
| SD1 | 8.600 | 8.600 | 8.000 | 8.000 |

Table 18 below lists conditional expression values according to the first to eighth embodiments of the present disclosure.

TABLE 18

| Conditional | Embodi- | Embodi- | Embodi- | Embodi- |
|---|---|---|---|---|
| Expression Value | ment 1 | ment 2 | ment 3 | ment 4 |
| \|f/f1\| + \|f/f2\| | 0.979 | 0.920 | 0.890 | 0.982 |
| f3/f4 | −1.588 | −1.572 | −1.510 | −1.480 |
| fG1/f | 1.352 | 1.457 | 1.538 | 1.677 |
| FOV/IMG HT | 5.977 | 6.116 | 6.329 | 6.362 |
| fG2/dG1G2 | 3.706 | 3.260 | 2.657 | 2.068 |
| h1/h2 | 2.026 | 2.026 | 2.026 | 2.079 |
| f/BFL | 2.193 | 2.198 | 2.217 | 2.359 |
| (F-number*SD1)/f | 1.248 | 1.275 | 1.276 | 1.247 |
| f/f1 | 0.856 | 0.800 | 0.767 | 0.784 |
| f/f2 | −0.123 | −0.120 | −0.124 | −0.199 |
| f/f3 | 2.465 | 2.230 | 2.566 | 2.579 |
| f/f4 | −3.914 | −3.504 | −3.875 | −3.817 |
| f/f5 | 4.781 | 4.702 | 4.209 | 4.035 |
| f/f6 | −6.231 | −5.939 | −5.227 | −5.574 |
| f/f7 | 2.503 | 2.212 | 2.049 | 2.467 |
| Conditional | Embodi- | Embodi- | Embodi- | Embodi- |
| Expression | ment 5 | ment 6 | ment 7 | ment 8 |
| \|f/f1\| + \|f/f2\| | 0.927 | 0.926 | 0.890 | 0.857 |
| f3/f4 | −1.325 | −1.206 | −1.210 | −1.223 |
| fG1/f | 2.501 | 2.501 | 2.502 | 2.502 |
| FOV/IMG HT | 6.918 | 6.910 | 6.910 | 6.902 |
| fG2/dG1G2 | 2.483 | 2.445 | 2.462 | 2.113 |
| h1/h2 | 2.079 | 2.079 | 2.079 | 2.079 |
| f/BFL | 2.283 | 2.251 | 2.255 | 2.262 |
| (F-number*SD1)/f | 1.512 | 1.496 | 1.387 | 1.339 |
| f/f1 | −0.264 | −0.264 | 0.644 | 0.626 |
| f/f2 | 0.662 | 0.662 | −0.247 | −0.231 |
| f/f3 | 1.459 | 1.352 | 1.343 | 1.377 |
| f/f4 | −1.934 | −1.630 | −1.625 | −1.685 |
| f/f5 | 2.476 | 2.541 | 2.586 | 2.893 |
| f/f6 | −3.340 | −3.534 | −3.613 | −3.880 |
| f/f7 | 1.361 | 1.267 | 1.301 | 1.336 |

According to embodiments of the present invention, low-light performance of a telephoto camera may be improved while minimizing an increase in a height of the telephoto camera. In addition, a clear image may be obtained even in a high-magnification mode.

While this disclosure includes specific embodiments, it will be apparent after an understanding of the disclosure of this application that various changes in form and detail may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group comprising a first lens and a second lens sequentially disposed in ascending numerical order along a first optical axis from an object side of the first lens group toward an image side of the first lens group;
a second lens group comprising a third lens, a fourth lens, a fifth lens, a sixth lens, and a seventh lens sequentially disposed in ascending numerical order along a second optical axis perpendicular to the first optical axis from an object side of the second lens group toward an imaging plane of the optical imaging system; and
an optical path conversion member disposed between the first lens group and the second lens group, the optical path conversion member being configured to change a traveling direction of light from a direction of the first optical axis to a direction of the second optical axis, wherein a conditional expression 0.5≤|f/f1|+|f/f2|≤1.5 is satisfied, where f is a focal length of the optical imaging system, f1 is a focal length of the first lens, and f2 is a focal length of the second lens.

2. The optical imaging system of claim 1, wherein the first lens and the second lens have refractive powers of opposite signs.

3. The optical imaging system according to claim 1, wherein a conditional expression 1≤fG1/f≤3 is satisfied, where fG1 is a focal length of the first lens group.

4. The optical imaging system of claim 1, wherein a conditional expression 2≤f3/f4 ≤−1 is satisfied, where f3 is a focal length of the third lens, and f4 is a focal length of the fourth lens.

5. The optical imaging system of claim 1, wherein a conditional expression 1.0≤(F-number*SD1)/f≤3.0 is satisfied, where SD1 is a diameter of the first lens, and F-number is a value representing a brightness of the optical imaging system.

6. The optical imaging system of claim 1, wherein a conditional expression 1.5≤f/BFL≤3.0 is satisfied, where f is a focal length of the optical imaging system, and BFL is a distance along the second optical axis from an image-side surface of the seventh lens to the imaging plane.

7. The optical imaging system of claim 1, wherein the third lens has a positive refractive power, the fourth lens has a negative refractive power, the fifth lens has a positive refractive power, the sixth lens has a negative refractive power, and the seventh lens has a positive refractive power.

8. The optical imaging system of claim 1, wherein an object-side surface of the third lens has a convex shape in a paraxial region thereof, and an image-side surface of the fourth lens has a concave shape in a paraxial region thereof.

9. The optical imaging system of claim 1, wherein the first lens has a positive refractive power, and an image-side surface of the first lens has a convex shape in a paraxial region thereof.

10. The optical imaging system of claim 1, wherein the first lens has a negative refractive power, and an image-side surface of the first lens has a concave shape in a paraxial region thereof.

11. The optical imaging system of claim 1, wherein the second lens has a negative refractive power, and an image-side surface of the second lens has a concave shape in a paraxial region thereof.

12. The optical imaging system of claim 1, wherein the second lens has a negative refractive power, and an image-side surface of the second lens has a convex shape in a paraxial region thereof.

13. The optical imaging system of claim 1, wherein the second lens has a positive refractive power, and an image-side surface of the second lens has a convex shape in a paraxial region thereof.

14. The optical imaging system of claim 1, wherein both an object-side surface and an image-side surface of the sixth lens have a concave shape in respective paraxial regions thereof.

15. The optical imaging system of claim 1, wherein an image-side surface of the fifth lens has a convex shape in a paraxial region thereof, and an object-side surface of the seventh lens has a convex shape in a paraxial region thereof.

16. An optical imaging system comprising:
an optical path conversion member configured to change a path of light passing through the optical imaging system;
a first lens group disposed on an object side of the optical path conversion member, the first lens group comprising a plurality of lenses sequentially disposed along a first optical axis; and
a second lens group disposed on an image side of the optical path conversion member, the second lens group comprising a plurality of lenses sequentially disposed along a second optical axis perpendicular to the first optical axis,
wherein a total number of lenses in the second lens group is greater than a total number of lenses in the first lens group, and
a conditional expression 1.0≤fG2/dG1G2≤4.5 is satisfied, where fG2 is a focal length of the second lens group, and dG1G2 is a distance along the first optical axis and the second optical axis between the first lens group and the second lens group.

17. The optical imaging system of claim 16, wherein the plurality of lenses of the first lens group comprises a first lens and a second lens sequentially disposed in ascending numerical order along the first optical axis from an object side of the first lens group toward the optical path conversion member,
the plurality of lenses of the second lens group comprises a third lens, a fourth lens, a fifth lens, a sixth lens, and a seventh lens sequentially disposed in ascending numerical order along the second optical axis from an object side of the second lens group toward an imaging plane of the optical imaging system, and
a conditional expression-2≤f3/f4≤−1 is satisfied, where f3 is a focal length of the third lens, and f4 is a focal length of the fourth lens.

18. The optical imaging system of claim 17, wherein the first lens and the second lens have refractive powers of opposite signs,
the third lens, the fifth lens, and the seventh lens have positive refractive powers, and the fourth lens and the sixth lens have negative refractive powers.

19. The optical imaging system of claim 16, wherein a conditional expression 5°/mm≤FOV/IMG HT≤9°/mm is satisfied, where FOV is a field of view of the optical imaging system, and IMG HT is one half of a diagonal length of an imaging plane of the optical imaging system.

20. The optical imaging system of claim 16, wherein a conditional expression 1≤h1/h2≤3 is satisfied, where h1 is a maximum height of the optical imaging system along the first optical axis, and h2 is a maximum height of the second lens group along the first optical axis.
